(19) United States
(12) Patent Application Publication
(10) Pub. No.: US 2025/0365844 A1
(43) Pub. Date: Nov. 27, 2025

(54) PLASMA GENERATION SYSTEM AND METHOD WITH MAGNETIC FIELD STABILIZATION

(71) Applicant: FUSE ENERGY TECHNOLOGIES CORP., San Leandro, CA (US)

(72) Inventors: Vahid DAMIDEH, Québec (CA); Jean-Christoph BTAICHE, Québec (CA); Andy LIAO, Québec (CA)

(73) Assignee: FUSE ENERGY TECHNOLOGIES CORP., San Leandro, CA (US)

(21) Appl. No.: 18/873,677

(22) PCT Filed: Jun. 14, 2023
(86) PCT No.: PCT/US2023/068442

§ 371 Date: Dec. 10, 2024

Related U.S. Application Data
(60) Provisional application No. 63/352,254, filed on Jun. 15, 2022.
(60) Provisional application No. 63/352,257, filed on Jun. 15, 2022.

(51) Int. Cl. H05H 1/06; H05H 1/48; H05H 1/54

(52) U.S. Cl. CPC H05H 1/06; H05H 1/481; H05H 1/54

(57) ABSTRACT

A plasma generation system is disclosed that includes a plasma generator and a magnetic field generator. The plasma generator includes a plasma chamber having a longitudinal Z-pinch axis. The plasma generator is configured to generate a Z-pinch plasma along the Z-pinch axis within the plasma chamber. The magnetic field generator is arranged with respect to the plasma generator and configured to generate, after the Z-pinch plasma is formed, a Z-pinch-stabilizing magnetic field extending longitudinally within the plasma chamber for stabilizing and compressing the Z-pinch plasma.

### RELATED PATENT APPLICATIONS

The present application claims priority to U.S. Provisional Patent Application No. 63/352,257 filed on Jun. 15, 2022 and U.S. Provisional Patent Application No. 63/352,254 filed on Jun. 15, 2022, the disclosures of which are incorporated herein by reference in their entireties.

### TECHNICAL FIELD

The technical field generally relates to plasma technology and, more particularly, to a plasma generation system and method with magnetic field stabilization for use, for example, in nuclear fusion power applications.

### BACKGROUND

Nuclear fusion energy is energy produced by a nuclear fusion process in which two or more lighter atomic nuclei are joined to form a heavier nucleus whose mass is less than the sum of the masses of the lighter nuclei. The difference in mass is released as energy, which can be harnessed to produce electricity. Fusion reactors are devices whose function is to harness fusion energy. One type of fusion reactor relies on magnetic plasma confinement. Such fusion reactors aim to confine high-temperature plasmas to sufficiently high-density with prolonged stability. Non-limiting examples of magnetic plasma confinement approaches include Z-pinch-configurations, magnetic mirror configurations, and toroidal configurations, for example, the tokamak and the stellarator. In Z-pinch configurations, a plasma column with an axial current flowing through it generates an azimuthal magnetic field that radially compresses the plasma, resulting in an increase of the fusion reaction rate. Conventional Z-pinch reactors suffer from instabilities that limit plasma lifetimes. Research bas found that stabilization of Z-pinch plasmas with a sheared flow can help reduce these instabilities, opening the possibility of producing and sustaining stable Z-pinches over longer timescales. Despite these advances, challenges remain in the field of Z-pinch-based plasma generation systems for use in fusion reactors as well as in various other fields and applications.

### SUMMARY

The present description generally relates to Z-pinch-based plasma generation systems and methods with magnetic field stabilization.

In accordance with an aspect, there is provided a plasma generation system, including:
a plasma generator including a plasma chamber having a longitudinal Z-pinch axis, the plasma generator being configured to generate a Z-pinch plasma along the Z-pinch axis within the plasma chamber; and
a magnetic field generator arranged with respect to the plasma generator and configured to generate, after the Z-pinch plasma has been formed, a Z-pinch-stabilizing magnetic field extending longitudinally within the plasma chamber for stabilizing and compressing the Z-pinch plasma.

In some embodiments, the plasma generation system further includes a control and processing unit including a processor and a non-transitory computer readable storage medium having stored thereon computer readable instructions that, when executed by the processor, cause the control and processing unit to control the plasma generator and the magnetic field generator to provide a time delay between the formation of the Z-pinch plasma and the generation of the Z-pinch-stabilizing magnetic field. In some embodiments, the time delay ranges from about 1 nanosecond to about 10 microseconds.

In some embodiments, the magnetic field generator includes an electromagnet and a current source coupled to the electromagnet to supply electric current to the electromagnet for the electromagnet to generate the Z-pinch-stabilizing magnetic field. In some embodiments, the electromagnet includes a set of magnetic field coils coaxially wound about, and longitudinally distributed along, the Z-pinch axis. In some embodiments, the set of magnetic field coils is disposed inside the plasma chamber. In some embodiments, the set of magnetic field coils is disposed outside the plasma chamber.

In some embodiments, the plasma generator includes:
a plasma confinement device including:
   a first electrode; and
   a second electrode arranged with respect to the first electrode to define therebetween the plasma chamber;
a precursor supply unit coupled to the plasma confinement device and configured to supply a plasma precursor within the plasma chamber, and
a power supply unit configured to apply a discharge driving signal to the first electrode and the second electrode to energize the plasma precursor into the Z-pinch plasma.

In some embodiments, the plasma precursor is a precursor gas. In some embodiments, the plasma precursor is a precursor plasma. In some embodiments, the plasma precursor includes deuterium, tritium, hydrogen, helium, or any combination thereof.

In some embodiments, the first electrode and the second electrode are provided in a coaxial arrangement with respect to the Z-pinch axis; and the second electrode includes: a rear electrode section disposed around the first electrode to define an acceleration region therebetween; and a front electrode section extending forwardly beyond the first electrode along the Z-pinch axis to define an assembly region, the acceleration region and the assembly region forming the plasma chamber; and the magnetic field generator is configured to generate the Z-pinch-stabilizing magnetic field within the assembly region. In some embodiments, the front electrode section includes a plurality of rods extending parallel to, and distributed azimuthally about, the Z-pinch axis. In some embodiments, the rods have an adjustable length along the Z-pinch axis to control a length of the plasma chamber.

In some embodiments, the magnetic field generator includes a set of magnetic field coils to generate the Z-pinch-stabilizing magnetic field, the set of magnetic field coils being coaxially wound about, and longitudinally distributed along, the Z-pinch axis.

In some embodiments, the set of magnetic field coils is disposed around the plurality of rods. In some embodiments, the front electrode section has a longitudinally tapered configuration, wherein each rod includes a rear rod segment extending longitudinally and radially inwardly from the rear electrode section, and a front rod segment extending longitudinally from the rear rod segment; and the set of magnetic field coils disposed at least around the rear rod segments of the plurality of rods.

In some embodiments, the plurality of rods is disposed around the set of magnetic field coils.

In some embodiments, the plasma generation system further includes a neutral beam injection unit configured to generate a beam of neutral particles and inject the beam of neutral particles into the plasma chamber to heat and stabilize the Z-pinch plasma.

In some embodiments, the plasma generator is configured to form the Z-pinch plasma with an embedded radially sheared axial flow. In some embodiments, the Z-pinch plasma is a linear Z-pinch plasma having a strictly axial flow.

In accordance with another aspect, there is provided a plasma generation method including: forming a Z-pinch plasma extending along a longitudinal Z-pinch axis of a plasma chamber; and generating, after the Z-pinch plasma has been formed, a Z-pinch-stabilizing magnetic field extending
longitudinally within the plasma chamber for stabilizing and compressing the Z-pinch plasma.

In some embodiments, the Z-pinch-stabilizing magnetic field is generated with a time delay ranging from about 1 nanosecond to about 10 microseconds after the Z-pinch plasma has been formed.

In some embodiments, generating the Z-pinch-stabilizing magnetic field includes providing an electromagnet and a current source coupled to the electromagnet; and operating the current source to supply electric current to the electromagnet for the electromagnet to generate the Z-pinch-stabilizing magnetic field.

In some embodiments, the electromagnet includes a set of magnetic field coils coaxially wound about, and longitudinally distributed along, the Z-pinch axis.

In some embodiments, the set of magnetic field coils is disposed inside the plasma chamber. In some embodiments, the set of magnetic field coils is disposed outside the plasma chamber.

In some embodiments, forming a Z-pinch plasma includes providing a plasma confinement device including a first electrode and a second electrode arranged with respect to the first electrode to define therebetween the plasma chamber; supplying a plasma precursor within the plasma chamber; and applying a discharge driving signal to the first electrode and the second electrode to energize the plasma precursor into the Z-pinch plasma.

In some embodiments, the plasma precursor is a precursor gas (e.g., a neutral or weakly ionized gas or gas mixture). In some embodiments, the plasma precursor is a precursor plasma (e.g., a low-temperature plasma).

In some embodiments, providing the plasma confinement device includes: disposing the first electrode and the second electrode are provided in a coaxial arrangement with respect to the Z-pinch axis; and providing the second electrode with a rear electrode section disposed around the first electrode to define an acceleration region therebetween, and a front electrode section extending forwardly beyond the first electrode along the Z-pinch axis to define an assembly region, the acceleration region and the assembly region forming the plasma chamber, and wherein the Z-pinch-stabilizing magnetic field is generated within the assembly region.

In some embodiments, the front electrode section includes a plurality of rods extending parallel to, and distributed azimuthally about, the Z-pinch axis.

In some embodiments, the method further includes providing a set of magnetic field coils being coaxially wound about, and longitudinally distributed along, the Z-pinch axis; and using the set of magnetic field coils to generate the Z-pinch-stabilizing magnetic field.

In some embodiments, the method further includes disposing the set of magnetic field coils disposed around the plurality of rods.

In some embodiments, the method further includes disposing the plurality of rods around the set of magnetic field coils.

In some embodiments, the method further includes injecting a beam of neutral particles into the plasma chamber to heat and stabilize the Z-pinch plasma.

In some embodiments forming the Z-pinch plasma including forming the Z-pinch plasma with an embedded radially sheared axial flow.

In accordance with another aspect, there is provided a plasma generation system including:
a plasma generator including a plasma chamber, the plasma generator being configured to generate a Z-pinch plasma in the plasma chamber; and
a neutral beam injection system coupled to the plasma generator, the neutral beam injection system being configured to inject a beam of neutral particles in the plasma chamber to enter into and heat the Z-pinch plasma.

In accordance with another aspect, there is provided a plasma generation system including:
a plasma confinement device including:
a first electrode; and
   a second electrode arranged with respect to the first electrode to define therebetween a plasma chamber configured to receive a plasma precursor;
a power supply configured to apply a voltage between the first electrode and the second electrode to convert the plasma precursor into a Z-pinch plasma in the plasma chamber; and
a neutral beam injection system coupled to the plasma confinement device and configured to inject a beam of neutral particles in the plasma chamber and into the Z-pinch plasma.

In some embodiments, the first electrode is an inner electrode, and the second electrode is an outer electrode surrounding the inner electrode and projecting axially beyond the inner electrode, wherein the Z-pinch plasma is configured to flow axially in a region of the plasma chamber extending between a front end of the inner electrode and a front end of the outer electrode.

In some embodiments, the neutral beam injection system is configured to inject the beam of neutral particles in the plasma chamber via an injection port formed in the inner electrode, or via an injection port formed in the outer electrode, or via both an injection port formed in the inner electrode and an injection port formed in the outer electrode.

In some embodiments, an injection angle between an injection direction, along which the beam of neutral particles is injected in the plasma chamber, and a pinch axis, along which the Z-pinch plasma is flowing, is equal to zero. In other embodiments, the injection angle is different from zero.

In some embodiments, the neutral beam injection system is configured to inject a plurality of beams of neutral particles from a plurality of injection ports provided at different locations with respect to the plasma chamber.

In some embodiments, the plasma precursor may include a neutral gas or gas mixture. In other embodiments, the plasma precursor may include a partially (e.g., weakly) ionized gas or gas mixture, or a plasma (e.g., a low-temperature plasma).

In some embodiments, the beam of neutral particles may include isotopes of hydrogen, for example, deuterium or a mixture of deuterium and tritium.

In some embodiments, the Z-pinch plasma has an embedded radially sheared axial flow.

In accordance with another aspect, there is provided a plasma generation system including:
a plasma confinement device including:
   an inner electrode; and
   an outer electrode surrounding the inner electrode to define therebetween an acceleration region configured to contain an initial plasma, the outer electrode projecting axially beyond the inner electrode to define an assembly region adjacent the acceleration region, the assembly region extending between a front end of the inner electrode and a front end of the outer electrode;
a power supply configured to apply a voltage between the inner electrode and the outer electrode to cause the initial plasma to (i) flow along the acceleration region and into the assembly region and (ii) be compressed into a Z-pinch plasma that flows axially in the assembly region between the front end of the inner electrode and the front end of the outer electrode; and
a neutral beam injection system coupled to the plasma confinement device and configured to inject a beam of neutral particles in the assembly region to be coupled into and heat the Z-pinch plasma.

In accordance with another aspect, there is provided a plasma generation method including:
forming a Z-pinch plasma in a plasma chamber; and
injecting a beam of neutral particles in the plasma chamber to enter into and heat the Z-pinch plasma.

In some embodiments, forming the Z-pinch plasma in the plasma chamber includes:
introducing a plasma precursor in the plasma chamber, and
applying a voltage across the plasma chamber to energize and compress the plasma precursor into the Z-pinch plasma.

In accordance with another aspect, there is provided a plasma generation method including:
forming or introducing an initial plasma in an acceleration region defined between an inner electrode and an outer electrode of a plasma confinement device, the outer electrode projecting axially beyond the inner electrode to define an assembly region adjacent the acceleration region, the assembly region extending between a front end of the inner electrode and a front end of the outer electrode;
applying a voltage between the inner electrode and the outer electrode to cause the initial plasma to (i) flow along the acceleration region and into the assembly region and (ii) be compressed into a Z-pinch plasma flowing along the longitudinal axis in the assembly region; and
injecting, with a neutral beam injection system coupled to the plasma confinement device, a beam of neutral particles in the assembly region to be coupled into and heat the Z-pinch plasma.

Other method and process steps may be performed prior, during, or after the steps described herein. The order of one or more steps may also differ, and some of the steps may be omitted, repeated, and/or combined, as the case may be.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features may be combined with one another unless stated otherwise.

### BRIEF DESCRIPTION OF THE DRAWINGS

FIGS. 1 to 5 are schematic representations of a conventional Z-pinch plasma generation system at five different stages of the Z-pinch formation.

FIG. 6 is a flow diagram of a plasma generation method, in accordance with an embodiment.

FIG. 7 is a schematic longitudinal cross-sectional view of a plasma generation system, in accordance with an embodiment.

FIG. 8 is a schematic front cross-sectional view of the plasma generation system of FIG. 7.

FIG. 9 is a schematic longitudinal cross-sectional view of the plasma generation system of FIG. 7, depicted in another operating position.

FIG. 10 is a schematic longitudinal cross-sectional view of a plasma generation system, in accordance with another embodiment.

FIG. 11 is a schematic longitudinal cross-sectional view of a plasma generation system, in accordance with another embodiment.

FIG. 12 is a schematic longitudinal cross-sectional view of a plasma generation system, in accordance with another embodiment.

FIG. 13 is a schematic longitudinal cross-sectional view of a plasma generation system, in accordance with another embodiment.

FIG. 14 is a schematic longitudinal cross-sectional view of a plasma generation system, in accordance with another embodiment.

FIG. 15 is a schematic longitudinal cross-sectional view of a plasma generation system, in accordance with another embodiment.

FIG. 16 is a schematic longitudinal cross-sectional view of a plasma generation system, in accordance with another embodiment.

FIG. 17 is a schematic longitudinal cross-sectional view of a plasma generation system, in accordance with another embodiment.

FIG. 18 is a schematic longitudinal cross-sectional view of a plasma generation system, in accordance with another embodiment.

### DETAILED DESCRIPTION

In the present description, similar features in the drawings have been given similar reference numerals. To avoid cluttering certain figures, some elements may not be indicated if they were already identified in a preceding figure. The elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. Such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined herein to mean “and/or”, unless stated otherwise.

The expressions “at least one of X, Y, and Z” and “one or more of X, Y, and Z”, and variants thereof, are understood to include X alone, Y alone, Z alone, any combination of X and Y, any combination of X and Z, any combination of Y and Z, and any combination of X, Y, and Z.

Ordinal terms such as “first”, “second”, “third”, and the like, to modify an element does not by itself connote any order, rank, priority, or precedence of one element over another, but are used merely to distinguish one element having a certain name from another element having otherwise the same name.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or an equivalent function or result). In some instances, the term “about” means a variation of ±10% of the stated value. It is noted that all numeric values used herein are assumed to be modified by the term “about”, unless stated otherwise. The term “between” as used herein to refer to a range of numbers or values defined by endpoints is intended to include both endpoints, unless stated otherwise.

The term “based on” as used herein is intended to mean “based at least in part on”, whether directly or indirectly, and to encompass both “based solely on” and “based partly on”. In particular, the term “based on” may also be understood as meaning “depending on”, “representative of”, “indicative of”, “associated with”, “relating to”, and the like.

The terms “match”, “matching”, and “matched” refer herein to a condition in which two elements are either the same or within some predetermined tolerance of each other. That is, these terms are meant to encompass not only “exactly” or “identically” matching the two elements, but also “substantially”, “approximately”, or “subjectively” matching the two elements, as well as providing a higher or best match among a plurality of matching possibilities.

The terms “connected” and “coupled”, and derivatives and variants thereof, refer herein to any connection or coupling, either direct or indirect, between two or more elements, unless stated otherwise. For example, the connection or coupling between elements may be mechanical, optical, electrical, magnetic, thermal, chemical, fluidic, logical, operational, or any combination thereof.

The term “concurrently” refers herein to two or more processes that occur during coincident or overlapping time periods. The term “concurrently” does not necessarily imply complete synchronicity and encompasses various scenarios including time-coincident or simultaneous occurrence of two processes; occurrence of a first process that both begins and ends during the duration of a second process; and occurrence of a first process that begins during the duration of a second process, but ends after the completion of the second process.

The present description generally relates to Z-pinch-based plasma generation systems and methods with magnetic field stabilization and compression.

The present techniques can find use in various fields and applications including, to name a few, fusion power generation, plasma sources, ions sources, plasma accelerators, neutron and high-energy photon generation, materials processing, linear Z-pinches, sheared-flow-stabilized Z-pinches, fusion-based medical devices (e.g., boron neutron capture therapy, electron therapy, proton therapy), and plasma focus devices.

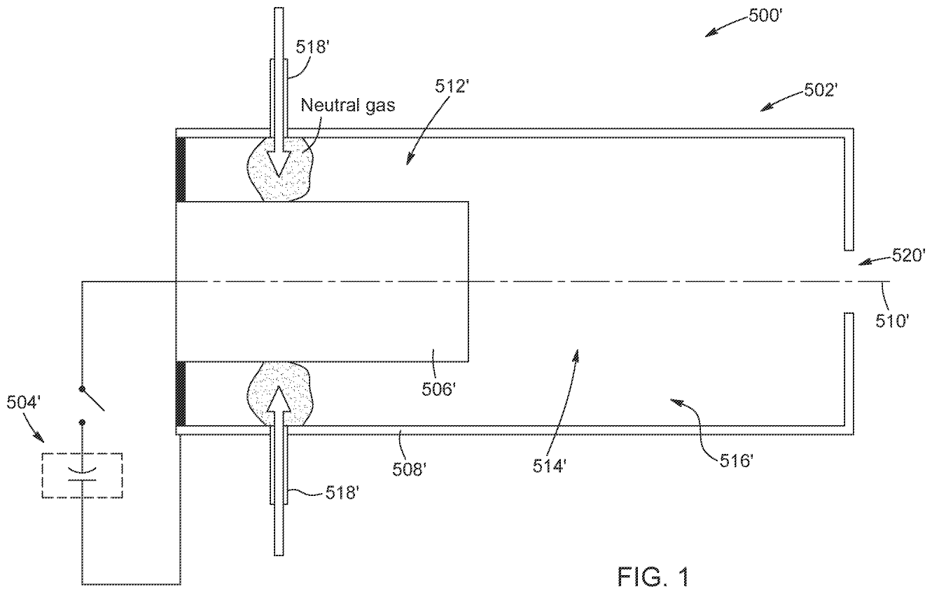

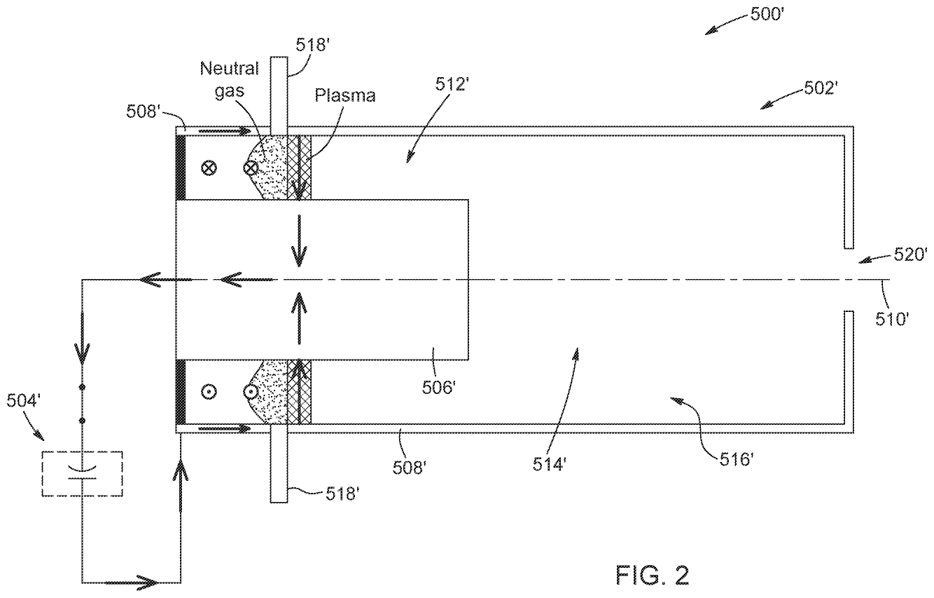

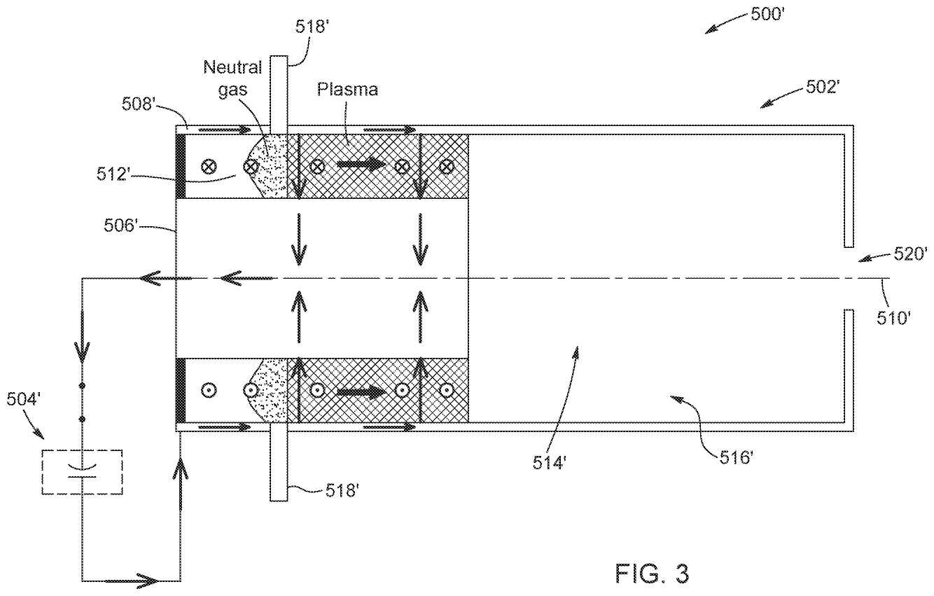

Magnetic plasma confinement is one of several approaches to achieving controlled fusion for power generation. Different types of configurations for magnetic plasma confinement have been devised and studied over the years, among which is the Z-pinch configuration. Referring to FIGS. 1 to 5, there are provided schematic representations of a conventional Z-pinch plasma generation system 500′ at different stages of the Z-pinch formation. The plasma generation system 500′ includes a plasma confinement device 502′ and a power supply unit 504′ configured to supply power to the plasma confinement device 502′. The plasma confinement device 502′ includes an inner electrode 506′ and an outer electrode 508′. The inner electrode 506′ and the outer electrode 508′ form a coaxial electrode arrangement extending along a longitudinal Z-pinch axis 510′. In the illustrated configuration, the outer electrode 508′ extends longitudinally beyond the inner electrode 506′. The annular volume extending between the inner electrode 506′ and the outer electrode 508′ defines a plasma acceleration region 512′, while the cylindrical volume surrounded by the outer electrode 508′ and extending beyond the inner electrode 506′ defines a Z-pinch assembly region 514′. The plasma acceleration region 512′ and the Z-pinch assembly region 514′ define a reaction chamber 516′ of the plasma confinement device 502′. The formation of a Z-pinch plasma can include injecting neutral gas in the acceleration region 512′ (FIG. 1), and applying, using the power supply unit 504′, a voltage between the inner electrode 506′ and the outer electrode 508′ (FIG. 2). The neutral gas can be injected into the acceleration region 512′ via one or more gas injection ports 518′ of the plasma confinement device 502′ (e.g., formed through the peripheral surface of the outer electrode 508′), the one or more gas injection ports 518′ being connected to a gas supply system including a neutral gas source (not shown). The power supply unit 504′ can include a high-voltage capacitor bank and a switch. The voltage applied between the inner electrode 506′ and the outer electrode 508′ is configured to ionize the neutral gas, resulting in the formation of an annular column or washer of plasma in the acceleration region 512′. The plasma column allows electric current to flow radially therethrough between the inner and outer electrodes 506′, 508′ (FIG. 2). The electric current that flows axially along the inner electrode 506″ generates an azimuthal magnetic field in the acceleration region 512 (FIG. 3).

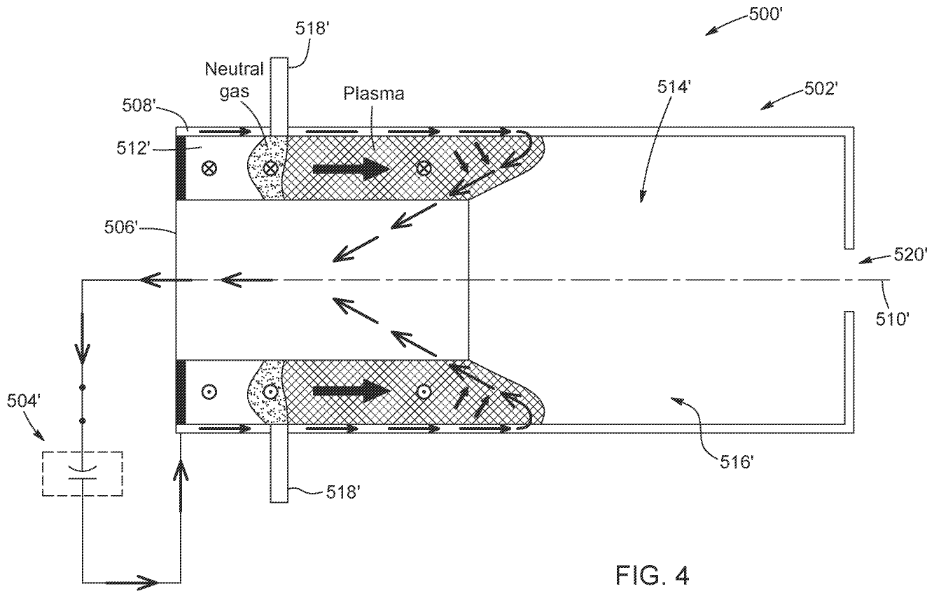

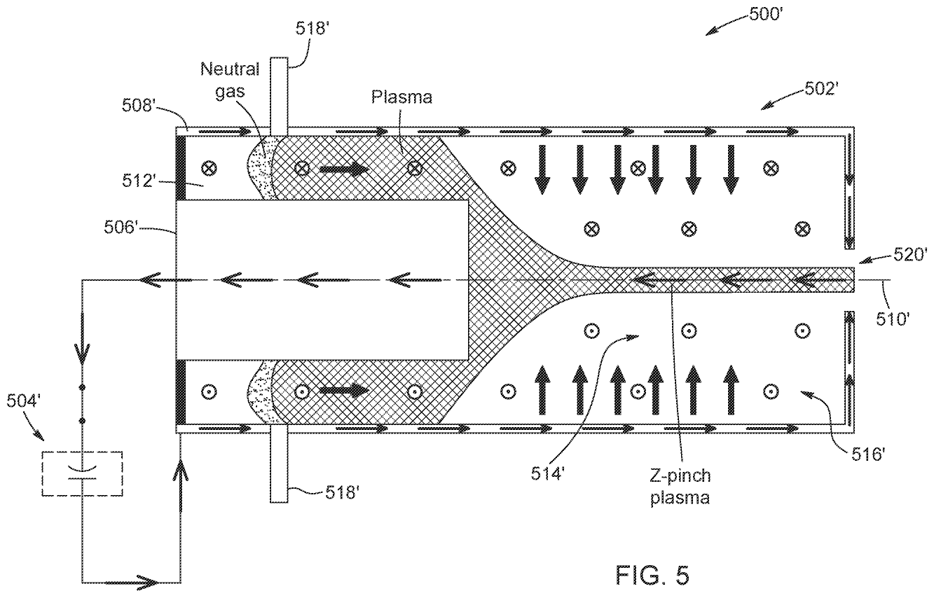

The interaction between the radial electric current flowing in the plasma column and the azimuthal magnetic field produces a Lorentz force in the axial direction that pushes and accelerates the plasma column axially forward along the acceleration region 512′ (FIG. 3) until the plasma column reaches the entrance of the assembly region 514′ and the Z-pinch formation begins (FIG. 4). In the assembly region 514′, the direction of the Lorentz force changes from longitudinal to radially inward, which makes the plasma column collapse inwardly toward the Z-pinch axis 510′ to complete the formation of a Z-pinch plasma (FIG. 5). The axial current flowing in the Z-pinch plasma generates an azimuthal magnetic field that exerts an inward magnetic pressure and an inward magnetic tension, which radially compress the Z-pinch plasma against the outward plasma pressure until an equilibrium is established. In this configuration, the Z-pinch plasma can continue to form and move along the assembly region 514′ for as long as neutral gas is supplied and ionized in the acceleration region 512′. In FIGS. 1 to 5, the plasma confinement device 502′ includes a plasma exit port 520′ configured to allow part of the Z-pinch plasma to exit the plasma confinement device 502′, so as to avoid a stagnation point in the plasma flow that could create instabilities.

By increasing the axial current to compress the Z-pinch plasma to sufficiently high density and temperature, fusion reactions can be achieved within the pinch, resulting in an exothermic energy release. In many applications, fusion reactions release their energy in the form of neutrons. A commonly used fusion reaction is the deuterium-tritium reaction, or D-T reaction, in which the fusion of one deuterium nucleus and one tritium nucleus produces one alpha particle and one neutron. Being chargeless, neutrons can escape from the magnetically confined plasma pinch and transfer their kinetic energy into thermal energy after they exit the confinement region. This thermal energy can be converted into electricity, for example, by transferring the heat generated to a working fluid used by a heat engine for generating electrical energy. The remaining fusion products have kinetic energy that can contribute more energy to the fusion process.

Conventional Z-pinch configurations are unstable due to the presence of magnetohydrodynamic (MHD) instabilities. A challenge in Z-pinch fusion research is devising ways of improving the control over instabilities to keep Z-pinch plasmas confined long enough to sustain ongoing fusion reactions. Recent advances have demonstrated that sheared plasma flows—that is, plasma flows with a radius-dependent axial velocity—can provide a promising stabilization approach to achieving and sustaining fusion conditions in Z-pinch configurations. For example, the velocity at the center of the Z-pinch plasma may range from about 20 km/s to about 150 km/s, while the velocity at the edge of the Z-pinch plasma may range from about 80 km/s to 150 km/s or may be as low as −20 km/s to 20 km/s. One of the keys to unlocking the potential of sheared-flow-stabilized Z-pinch fusion devices as these devices are scaled up in power input—and thus in power output—is to mitigate, circumvent, or otherwise control instabilities, turbulence, heat transfer, and other factors limiting plasma lifetime. This is because once the reaction becomes unstable, the pinch ceases, neutron production stops, and power generation shuts down. Researchers have theorized that fusion conditions resulting in viable net power output that can be met at high power input are achievable when the flow shear exceeds a certain threshold above which the Z-pinch is stable, this threshold depending on the magnetic field strength and the plasma density. It is appreciated that the theory, instrumentation, implementation, and operation of conventional sheared-flow-stabilized Z-pinch plasma confinement devices are generally known in the art and need not be described in detail herein other than to facilitate an understanding of the present techniques. Reference is made in this regard to International Patent Application PCT/US2018/019364 (published as WO 2018/156860) as well as the following doctoral dissertation: Golingo, Raymond, Formation of a Sheared Flow Z-Pinch (University of Washington, 2003). The contents of these two documents are incorporated herein by reference in their entirety.

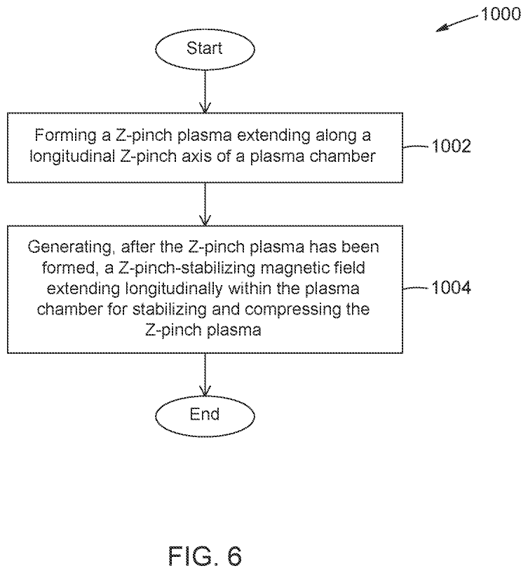

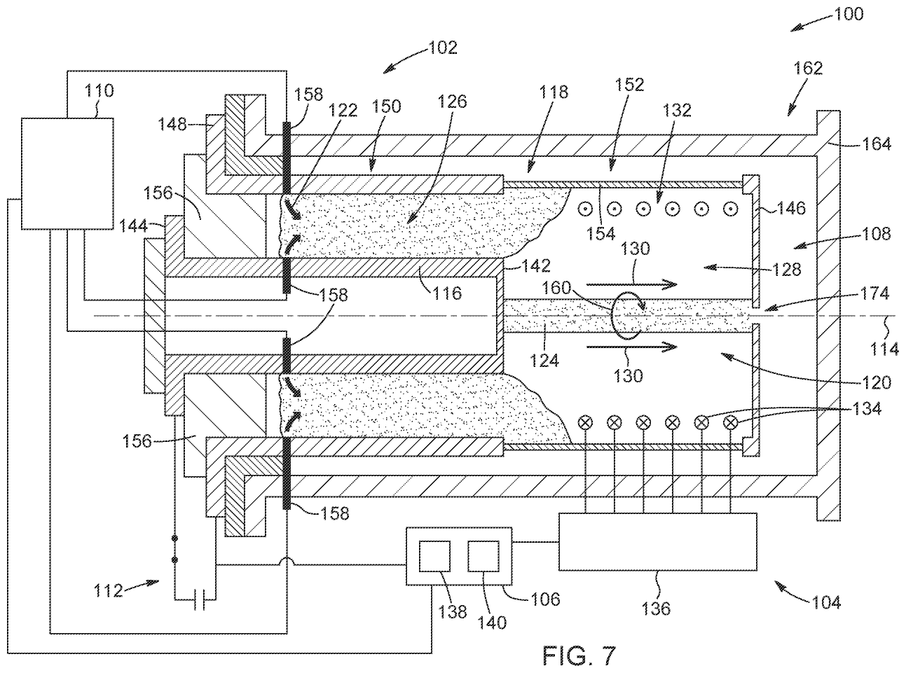

Referring to FIG. 6, there is illustrated a flow diagram of an embodiment of a plasma generation method 1000. Broadly described, the method 1000 can include a step 1002 of forming a Z-pinch plasma along a longitudinal Z-pinch axis of a plasma chamber, followed by step 1004 of generating, after the Z-pinch plasma has been formed, a longitudinal magnetic field within the plasma chamber for stabilizing the Z-pinch plasma. The method 1000 may be implemented in a plasma generation system—such as the ones depicted in FIGS. 7 to 18, or another suitable plasma generation system—that includes a plasma generator including the plasma chamber and configured to generate the Z-pinch plasma within the plasma chamber, and a magnetic field generator arranged with respect to the plasma generator and configured to generate, after the Z-pinch plasma is formed, the stabilizing magnetic field within the plasma chamber.

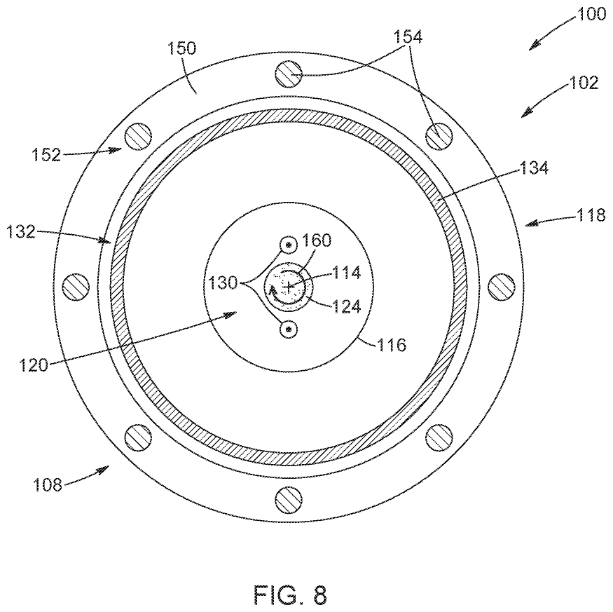

Referring to FIGS. 7 and 8, there are illustrated a schematic longitudinal cross-sectional view (FIG. 7) and a schematic partial front elevation cross-sectional view (FIG. 8) of a plasma generation system 100, in accordance with an embodiment. The plasma generation system 100 can be used, for example, in fusion power applications. The plasma generation system 100 generally includes a plasma generator 102, a magnetic field generator 104, and a control and processing device 106.

The plasma generator 102 includes a plasma confinement device 108, a precursor supply unit 110, and a power supply unit 112. The plasma confinement device 108 extends along a longitudinal Z-pinch axis 114. As used herein, the terms “longitudinal” and “axial” generally refer to a direction parallel to the Z-pinch axis 114, while the terms “radial” and “transverse” generally refer to a direction that lies in a plane perpendicular to the Z-pinch axis 114. The plasma confinement device 108 includes a first electrode 116 and a second electrode 118 arranged with respect to the first electrode 116 to define therebetween a plasma chamber 120. The precursor supply unit 110 is coupled to the plasma confinement device 108 and configured to supply a plasma precursor 122 within the plasma chamber 120. The power supply unit 112 is configured to apply a discharge driving signal (e.g., a discharge voltage) to the first electrode 116 and the second electrode 118 to energize the plasma precursor 122 into a Z-pinch plasma 124. In the embodiment illustrated in FIGS. 6 and 7, the first electrode 116 is an inner electrode and the second electrode 118 is an outer electrode that surrounds the inner electrode 116 to define to define an acceleration region 126 therebetween. Furthermore, the outer electrode 118 extends forwardly beyond the inner electrode 116 along the Z-pinch axis 114 to define an assembly region 128 adjacent the acceleration region 126. The volume occupied by the acceleration region 126 and the assembly region 128 defines the plasma chamber 120.

The term “Z-pinch plasma” broadly refers herein to a plasma that has an electric current flowing substantially along the longitudinal or axial direction Z of a cylindrical coordinate system (e.g., the Z-pinch axis 114 in FIG. 7). The axial electrical current generates an azimuthal magnetic field that radially compresses, or pinches, the plasma by the Lorentz force. It is appreciated that, in some instances, terms such as “Z-pinch”, “zeta pinch”, “plasma pinch”, “pinch”, “plasma arc” may be used interchangeably with the term “Z-pinch plasma”.

The magnetic field generator 104 is arranged with respect to the plasma generator 102 and configured to generate, after the Z-pinch plasma 124 has been formed, a Z-pinch-stabilizing magnetic field 130 extending longitudinally within the plasma chamber 120 for stabilizing the Z-pinch plasma 124. The magnetic field generator 104 can include an electromagnet 132 (e.g., a magnetic field coil unit having one or more magnetic coils 134) and a current source 136 coupled to the electromagnet 132 to supply electric current to the electromagnet 132 for the electromagnet 132 to generate the Z-pinch-stabilizing magnetic field 130.

The control and processing device 106 is configured to control, monitor, and coordinate the functions and operations of various components of the plasma generation system 100 (e.g., the plasma confinement device 108, the precursor supply unit 110, the power supply unit 112, and the magnetic field generator 104), as well as various operating conditions (e.g., temperature, pressure, flow rate, and power conditions). The control and processing device 106 can include a processor 138 and a memory 140.

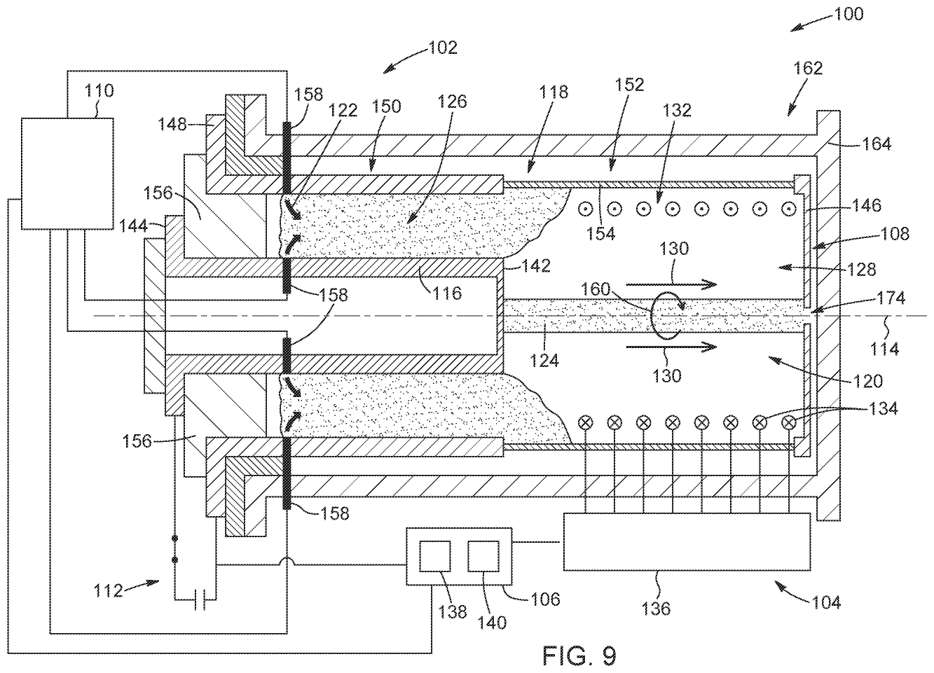

More details regarding the structure, configuration, and operation of these components and other possible components of the plasma generation system 100 are provided below. It is appreciated that FIGS. 7 and 8 are simplified schematic representations that illustrate certain features and components of the plasma generation system 100, such that additional features and components that may be useful or necessary for its practical operation may not be specifically depicted, and likewise for FIGS. 9 to 18 described below. Non-limiting examples of such additional features and components can include, to name a few, power supplies, electrical connections, gas sources, gas supply lines (e.g., conduits, such as pipes or tubes), pressure and flow control devices (e.g., pumps, valves, regulators, restrictors), temperature control devices, operation monitoring and diagnostic devices (e.g., sensors), processors and controllers, and other types of hardware and equipment.

The inner electrode 116 and the outer electrode 118 both have an elongated configuration along the Z-pinch axis 114 of the plasma confinement device 108. The inner electrode 116 has a front end 142 and a rear end 144, and the outer electrode 118 has a front end 146 and a rear end 148. In the illustrated arrangement, the inner electrode 116 and the outer electrode 118 both have a substantially cylindrical configuration with a circular cross-section transverse to the Z-pinch axis 114. Depending on the application, the inner electrode 116 may have a full or hollow configuration. In the illustrated embodiment, the outer electrode 118 coaxially encloses the inner electrode 116. However, various other electrode configurations can be used in other embodiments. Non-limiting examples include, to name a few, non-coaxial arrangements, non-circularly symmetric transverse cross-sections, three-electrode arrangements, and the like.

The inner electrode 116 and the outer electrode 118 may each be made of any suitable electrically conductive material, such as various metals and metal alloys. Non-limiting examples include, to name a few, tungsten-coated copper and graphite. In some embodiments, the inner electrode 116 may have a length ranging from about 25 cm to about 10 meters and a radius ranging from about 2 cm to about 1 m, while the outer electrode 118 may have a length ranging from about 50 cm to about 15 m, a radius ranging from about 6 cm to about 2 m or more, and a wall thickness ranging from about 6 mm to about 12 mm, although other electrode dimensions may be used in other embodiments. Depending on the application, the inner electrode 116 and the outer electrode 118 may be of varying sizes, shapes, compositions, and configurations.

In the illustrated embodiment, the outer electrode 118 includes a rear electrode section 150 disposed around the inner electrode 116 and enclosing the acceleration region 126, and a front electrode section 152 extending longitudinally beyond the front end 142 of the inner electrode 116 and enclosing the assembly region 128. The rear electrode section 150 bas a hollow cylindrical body with a continuous peripheral surface. The front electrode section 152 includes a plurality of rods 154 extending parallel to, and distributed azimuthally about, the Z-pinch axis 114. Thus, the front electrode section 152 has a discontinuous peripheral surface, with inter-rod gaps provided by the azimuthal spaces between the rods 154. The rods 154 may be made of any suitable electrically conductive material, such as various metals and metal alloys. In some embodiments, the rods 154 may have a radius ranging from about 0.5 cm to about 5 cm, and a length substantially equal to, or slightly less than, the length of the assembly region 128. Depending on the application, the rods 154 may or may not all have the same dimensions or compositions. In the illustrated embodiment, the front electrode section 152 includes eight rods 154, which are evenly spaced apart azimuthally at a same radial distance from the Z-pinch axis 114, as depicted in FIG. 8. However, in other embodiments, less symmetrical or otherwise different arrangements may be used, which may include fewer or more rods 154. For example, in some embodiments, the number of rods 154 may range from about 5 to about 100. In some embodiments, the length of the rods 154 can be adjusted, that is, either increased or decreased, to control the length of the assembly region 128. This is illustrated in FIG. 9, where the length of the rods 154 has been increased compared to their length depicted in FIG. 7.

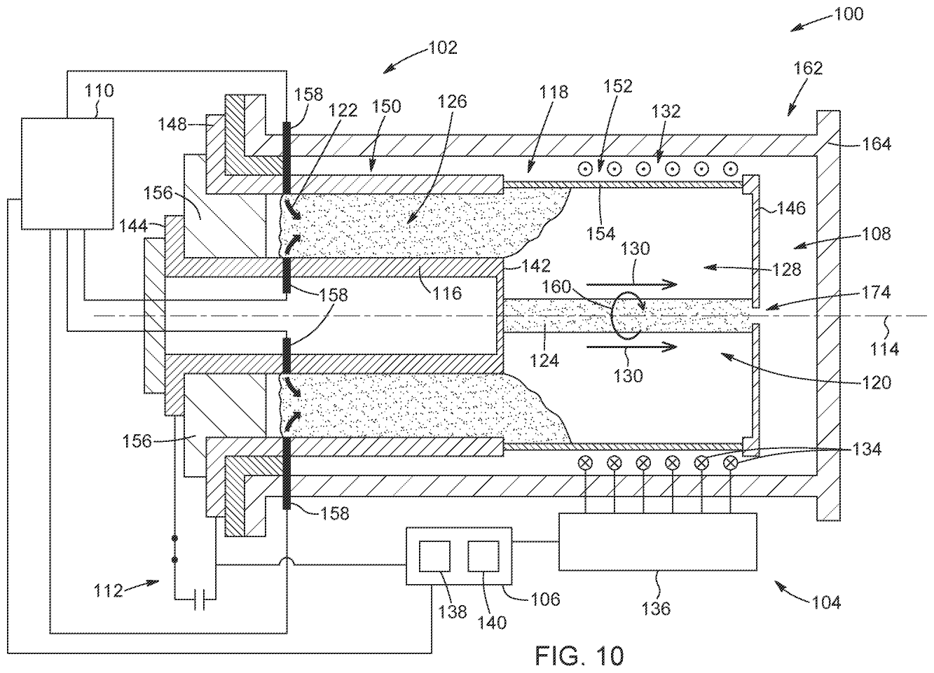

It is appreciated that the provision of gaps or interruptions in the peripheral surface of the front electrode section 152 can allow the Z-pinch-stabilizing magnetic field 130 to be generated within the plasma chamber 120 with the electromagnet 132 located either inside the plasma chamber 120 (i.e., with the magnetic field coils 134 surrounded by the rods 154, as in FIGS. 7 and 8) or outside the plasma chamber 120 (i.e., with the magnetic field coils 134 surrounding the rods 154, as in FIG. 10). When the front electrode section 152 is provided with a hollow tubular body having a continuous, uninterrupted cylindrical peripheral wall made of an electrically conducting material, disposing the electromagnet 132 outside the plasma chamber 120 (i.e., with the magnetic field coils 134 surrounding the front electrode section 152) may not be possible or practical, as the front electrode section 152 may prevent the Z-pinch-stabilizing magnetic field 130 from penetrating into the plasma chamber 120. One reason is that the discharge driving signal applied to the inner electrode 116 and the outer electrode 118 is generally a fast pulse discharge, so that the electrical current generated in the outer electrode 118 is confined by the skin effect to an outer layer of the outer electrode 118. In this case, if the magnetic field 130 were to be applied from a source located outside the outer electrode 118, the electrical current carried in the outer layer of the outer electrode 118 would act to diamagnetically repel the magnetic field 130 and prevent it from penetrating through the outer electrode 118 and inside the plasma chamber 120.

In some embodiments, providing the magnetic field coils 134 around the rods 154 and outside the plasma chamber 120, as in FIG. 10, can be advantageous or required in some applications. Non-limiting examples of possible advantages include easier engineering and construction; reduced likelihood that the magnetic field coils 134 are sputtered by plasma produced in the plasma chamber 120; and reduced likelihood that the magnetic field coils 134 disturb the electric field distribution between the inner electrode 116 and the outer electrode 118. It is noted that the embodiment of FIG. 10 shares several features with the embodiment of FIGS. 7 and 8, which need not be described in detail again.

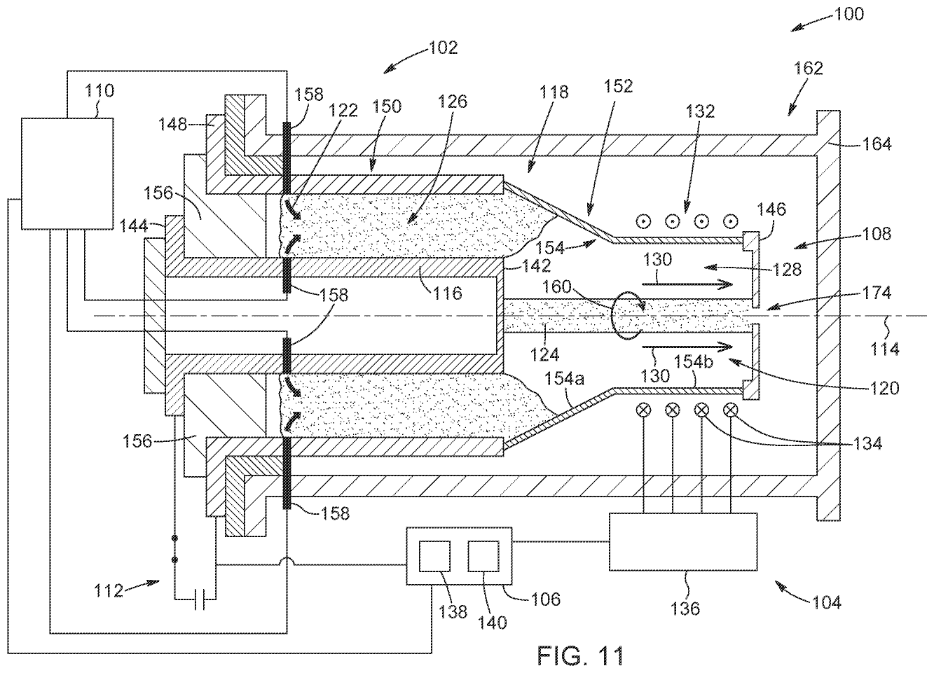

Referring to FIG. 11, there is illustrated a schematic longitudinal cross-sectional view of a plasma generation system 100, in accordance with another embodiment. The embodiment of FIG. 11 shares several features with the embodiment of FIG. 10, which need not be described again other than to highlight differences between them. In FIG. 11, the front electrode section 152 of the outer electrode 118 has a longitudinally tapered configuration, in which the front electrode section 152 tapers radially inwardly as it extends forwardly. Such a configuration can allow the magnetic field coils 134 to be disposed radially closer to the longitudinal Z-pinch axis 114, while still being disposed radially outwardly of the rods 154. Disposing the magnetic field coils 134 closer to the Z-pinch axis 114 can be advantageous because it can allow the strength of the Z-pinch-stabilizing magnetic field 130 acting on the Z-pinch plasma 124 to be increased. Another advantage of disposing the coils 134 closer to the Z-pinch axis 114 is that the inductance of the coils 142 can be reduced, which can lead to shorter rise times for the coil current. In the illustrated embodiment, each of the rods 154 has an elbowed shape including a rear rod segment 154a and a front rod segment 154b. The rear rod segment 154a extends longitudinally and radially inwardly (i.e., at a tapering angle) from the rear electrode section 150, and the front rod segment 154b extends longitudinally between the rear rod segment 154a and the front end 146 of the outer electrode 118. It is appreciated that the plurality of azimuthally spaced and longitudinally and radially inwardly extending rear rod segments 154a defines the longitudinally tapered configuration of the front electrode section 152. In the illustrated embodiment, the magnetic field coils 134 are disposed around the front rod segments 154b of the rods 154, but not around the rear rod segments 154a. However, in other embodiments, one or more of the magnetic field coils 134 may be disposed around the rear rod segments 154a.

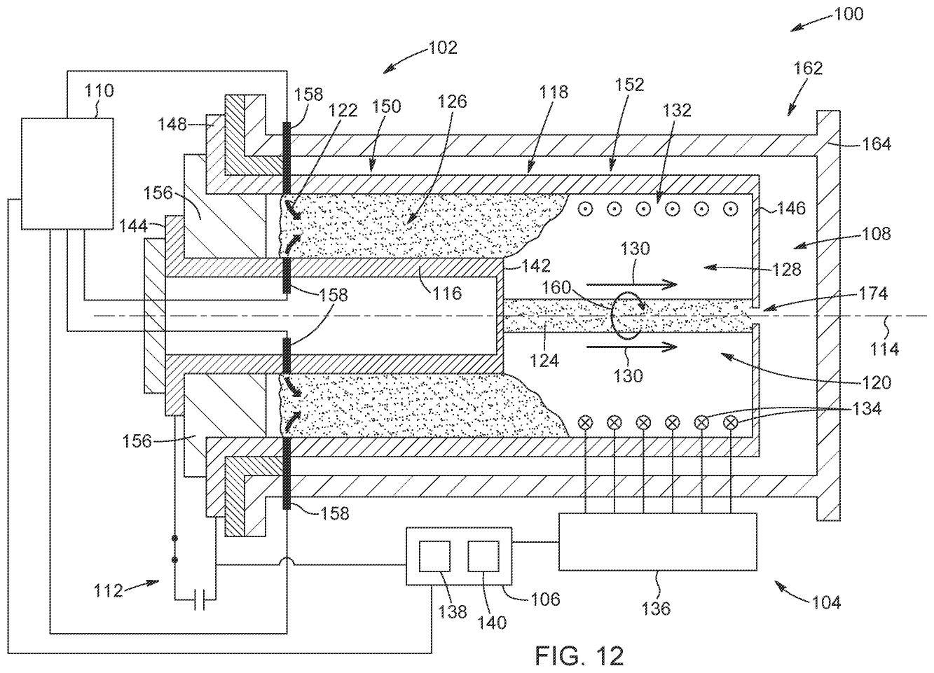

Referring to FIG. 12, there is illustrated a schematic longitudinal cross-sectional view of a plasma generation system 100, in accordance with another embodiment. The embodiment of FIG. 10 shares several features with the embodiment of FIGS. 7 and 8, which need not be described again other than to highlight differences between them. In FIG. 12, the front electrode section 152 of the outer electrode 118 has a continuous, uninterrupted cylindrical peripheral wall, rather than including a distribution of rods 154 with inter-rod gaps as in FIGS. 7 and 8. In FIG. 10, the magnetic field coils 134 are disposed within the plasma chamber 120, near the inner peripheral surface of the front electrode section 152.

Returning to FIGS. 7 and 8, the plasma confinement device 108 can also include an electrode insulator 156 disposed between the inner electrode 116 and the outer electrode 118. The electrode insulator 156 is configured to provide electrical insulation between the inner electrode 116 and the outer electrode 118, so as to prevent or help prevent unwanted charge buildup and other undesirable electrical phenomena that could adversely affect the operation of the plasma confinement device 108. In the illustrated embodiment, the electrode insulator 156 has an annular cross-sectional shape and is disposed near the rear ends 144, 148 of the inner and outer electrodes 116, 118. The electrode insulator 156 may be made of any suitable electrically insulating material, for example, glass, ceramic, glass-ceramic, and polymer materials. More specific examples of possible materials include, to name a few, alumina, boron nitride, borosilicate glass, porcelain, quartz, polytetrafluoroethylene (PTFE), MACOR®, and Teflon®. Depending on the application, the electrode insulator 156 can be of varying sizes, shapes, compositions, locations, and configurations.

In the illustrated embodiment, the acceleration region 126 has a substantially annular cross-sectional shape defined by the cross-sectional shapes of the inner electrode 116 and the rear electrode section 150 of the outer electrode 118. In some embodiments, the acceleration region 126 may have a length ranging from about 25 cm to about 10 m, and an annular thickness ranging from about 2 cm to about 50 cm, although other dimensions may be used in other embodiments. The acceleration region 126 is configured to receive the plasma precursor 122 from the precursor supply unit 110 via one or more precursor supply ports 158 formed through either or both of the inner electrode 116 and the outer electrode 118. In the illustrated embodiment, the precursor supply unit 110 is depicted as including four precursor supply ports 158 located at the same longitudinal position near the ends 144, 148 of the inner and outer electrodes 116, 118. The four precursor supply ports 158 include two injection ports formed through the inner electrode 116 at opposite azimuthal positions and two injection ports formed through the outer electrode 118 at the same opposite azimuthal positions. However, depending on the application, the one or more precursor supply ports 158 may be formed only through the inner electrode 116, only through the outer electrode 118, or through both the inner electrode 116 and the outer electrode 118. It is also appreciated that the number of precursor supply ports 158, as well as their longitudinal, azimuthal, and radial arrangements with respect to the acceleration region 126, can be varied to suit the needs or preferences of a particular application. Furthermore, different precursor supply ports 158 may be configured to supply plasma precursors 122 of different types and/or having different properties and parameters.

The assembly region 128 has a substantially circular cross-sectional shape defined by the cross-sectional shape of the front electrode section 152 of the outer electrode 118. The assembly region 128 extends from the front end 142 of the inner electrode 116 to the front end 146 of the outer electrode 118. In the illustrated embodiment, the front end 142 of the inner electrode 116 is flat, and the front end 146 of the outer electrode 118 defines a front endwall of the plasma confinement device 108. However, non-flat geometries (e.g., half-spherical, conical, tapered, either concave or convex) for the front ends 142, 146 of either or both of the inner and outer electrodes 116, 118 are possible in other embodiments. The assembly region 128 is configured to sustain the Z-pinch plasma 124 along the Z-pinch axis 114 between the front end 142 of the inner electrode 116 and the front end 146 of the outer electrode 118. In some embodiments. the assembly region 128 may have a length ranging from about 25 cm to about 5 m, although other dimensions may be used in other embodiments.

In some embodiments, the plasma confinement device 108 may include a plasma exit port 174 configured to allow part of the Z-pinch plasma 124 to exit the plasma confinement device 108, for example, to avoid a stagnation point in the plasma flow that could create instabilities in the Z-pinch plasma 124. In the illustrated embodiment, the plasma exit port 174 is provided as an opening formed on the Z-pinch axis 114 at the front end 146 of the outer electrode 118. In other embodiments, the plasma exit port 174 may be provided at other locations of the plasma confinement device 108, for example, through the peripheral wall of the outer electrode 118. In yet other embodiments, a plurality of plasma exit ports may be provided.

Referring still to FIGS. 7 and 8, the power supply unit 112 is coupled to the inner electrode 116 and the outer electrode 118 via appropriate electrical connections. The term “power supply unit” refers herein to any device or combination of devices configured to supply electrical power into a form usable by another device or combination of devices. It is appreciated that while the power supply unit 112 depicted in FIG. 7 as a single entity for illustrative purposes, the term “power supply unit” should not be construed as being limited to a single power supply and, accordingly, in some embodiments the power supply unit 112 may include a plurality of power supplies.

The power supply unit 112 may include a high-power pulsed-DC source (e.g., a capacitor bank, a Marx generator, or a linear transformer driver), a switch (e.g., a spark gap, an ignitron, or a semiconductor switch), and a pulse shaping network (including, e.g., inductors, resistors, ignitrons, diodes, and the like). Other suitable types of power supplies may be used in other embodiments, including DC power supplies, such as DC grids, voltage source converters, and homopolar generators. Depending on the application, the power supply unit 112 may be voltage-controlled or current-controlled. It is appreciated that the instrumentation, implementation, and operation of power supplies used in plasma generation systems are generally known in the art and need not be described in greater detail herein.

The power supply unit 112 is configured to supply power to apply a discharge driving signal to inner electrode 116 and the outer electrode 118 to generate an accelerating electric field across the acceleration region 126. The accelerating electric field is configured to energize the plasma precursor 122 to cause a plasma flow to move along the acceleration region 126 and into the assembly region 128, where the plasma flow can be compressed into the Z-pinch plasma 124 onto the Z-pinch axis 114. In some embodiments, the discharge driving signal can be a voltage pulse having a peak magnitude ranging from about 1 kV to about 100 kV, although other peak magnitude voltage values, may be used in other embodiments. The operation of the power supply unit 112 may be selected in view of the nature and parameters of the plasma precursor 122 injected inside the acceleration region 126 and the configuration and operating conditions of the plasma confinement device 108 in order to favor the acceleration (and possibly the ionization) of the plasma precursor 122 along the acceleration region 126 and its compression into the Z-pinch plasma 124 in the assembly region 128.

In some embodiments, the operation of applying the discharge driving signal by the power supply unit 112 can be initiated after initiating the operation of supplying the plasma precursor 122 to the acceleration region 126 by the precursor supply unit 110. For example, in some embodiments, the operation of applying the discharge driving signal can be initiated with a time delay ranging from about 1 ns to about 100 μs after the operation of supplying the plasma precursor 122 to the acceleration region 126. However, in other embodiments, the operation of applying the discharge driving signal can be initiated before or at the same time as initiating the process supplying the plasma precursor 122 to the acceleration region 126. In some embodiments, the plasma precursor 122 can include fusion reactants, such as deuterium, tritium, hydrogen, helium, or any combination thereof (e.g., a deuterium-tritium mixture).

In some embodiments, the precursor supply unit 110 may be configured to supply the plasma precursor 122 as a neutral or partially (e.g., weakly) ionized gas or gas mixture (i.e., as a precursor gas 122). In such embodiments, the formation of the Z-pinch plasma 124 can proceed similarly to as described above with respect to FIGS. 1 to 5. That is, upon applying a discharge driving signal (e.g., a discharge voltage) to the inner and outer electrodes 116, 118 by the power supply unit 112, an electrical field is created in the acceleration region 126 that ionizes and energizes the precursor gas 122 into an annular plasma column. The plasma column allows electric current to flow radially therethrough between the inner electrode 116 and the outer electrode 118. The electric current that flows axially along the inner electrode 116 and the outer electrode 118 generates an azimuthal magnetic field in the acceleration region 126. The interaction between the radial electric current flowing in the plasma column and the azimuthal magnetic field produces a Lorentz force in the axial direction that causes the plasma column to propagate and be accelerated axially forward along the acceleration region 126 until the plasma column reaches the entrance of the assembly region 128 and the Z-pinch plasma 124 begins to form. In the assembly region 128, the direction of the Lorentz force changes from longitudinal to radially inward, which makes the plasma column collapse toward the Z-pinch axis 114 to complete the formation of the Z-pinch plasma 124. The axial current flowing in the Z-pinch plasma 124 generates an azimuthal magnetic field 160. This magnetic field 160 produces an inward magnetic pressure that radially compresses the Z-pinch plasma 124 against the outward plasma pressure until an equilibrium is established. In this configuration, the Z-inch plasma 124 can continue to form and move along the assembly region 128 for as long as the precursor gas 122 is supplied and ionized in the acceleration region 126.

In other embodiments, the precursor supply unit 110 may be configured to supply the plasma precursor 122 as an already-formed plasma (i.e., as a precursor plasma 122). For example, the precursor supply unit 110 may be configured to form precursor plasma 122 outside the acceleration region 126 and then inject the precursor plasma 122 into the acceleration region 126 via the one or more precursor supply ports 158. The precursor plasma 122 thus injected can be accelerated along the acceleration region 126 and compressed into the Z-pinch plasma 124 in the assembly region 128. In such embodiments, the Z-pinch plasma 124 can be formed as a result of two independently controlled processes: (i) a plasma formation and injection process, and (ii) a plasma acceleration and compression process. Such embodiments can provide enhanced control over the Z-pinch parameters and properties (e.g., plasma density, temperature, velocity, magnetic field, lifetime, and the like). Non-limiting examples of plasma generation systems and methods that use such or similar plasma formation and injection techniques are disclosed in International Patent Application PCT/US2021/062830, filed Dec. 10, 2021, and published as WO 2022/125912 on Jun. 16, 2022, the contents of which are incorporated herein by reference in their entirety. It is appreciated that, in such embodiments, the precursor supply unit 110 may include various types of plasma sources and may be configured to implement various plasma formation and injection techniques to form the precursor plasma 122 and inject the precursor plasma 122 into the acceleration region 126. Non-limiting examples of suitable plasma sources are disclosed in U.S. Provisional Patent Application Ser. No. 63/352,251, filed Jun. 15, 2022, the contents of which are incorporated herein by reference in their entirety. Other examples of such possible plasma sources can include gas injected washer plasma guns, plasma thrusters (e.g., Hall effect thrusters and MHD thrusters), high-power helicon plasma sources, RF plasma sources; and laser-based plasma sources.

In some embodiments, precursor plasma 122 may be a plasma having the following properties and parameters: an electron temperature ranging from about 1 eV to about 100 eV, an ion temperature ranging from about 1 eV to about 100 eV, an electron density ranging from about 10¹³ cm⁻³ to about 10¹⁶ cm⁻³, an ion density ranging from about 10¹³ cm⁻³ to about 10¹⁶ cm⁻³, and a degree of ionization ranging from about 50% to about 100%. Depending on the application, the plasma may be magnetized or unmagnetized.

In yet other embodiments, the precursor supply unit 110 may be configured to supply the plasma precursor 122 as a mixture of neutral or partially ionized gas and plasma.

In some embodiments, the Z-pinch plasma 124 may have the following properties and parameters: a plasma radius ranging from about 0.1 mm to about 5 mm, a magnetic field ranging from about 0.1 T to about 20 T, an electron temperature ranging from about 100 e V to about 20 keV, an ion temperature ranging from about 100 eV to about 20 keV, an electron density ranging from about 10¹⁷ cm⁻³to about 10²⁰ cm⁻³, an ion density ranging from about 10¹⁷ cm⁻³ to about 10²⁰ cm⁻³, and a stable lifetime exceeding 10 μs (e.g., up to 1 ms). These values are provided by way of example, so that other values may be used in other embodiments. In some embodiments, a radially sheared axial flow can be embedded in the Z-pinch plasma 124 due to the velocity of the plasma flow as it exits the acceleration region 126 and enters the assembly region 128, where it is compressed into the Z-pinch plasma 124. However, in other embodiments, the Z-pinch plasma 124 may be generated without a radial velocity shear (e.g., as a linear Z-pinch with a purely axial flow).

In some embodiments, the plasma generation system 100 may be configured to compress and heat the Z-pinch plasma 124 sufficiently to reach fusion conditions, that is, plasma temperature and density conditions at which fusion reactions can occur inside the Z-pinch plasma 124. In such embodiments, the output energy produced by the fusion reactions, which typically involve the generation of neutrons, exceeds the input energy required to establish fusion conditions. In fusion power applications, the output energy can be converted into electricity,

Referring still to FIGS. 6 and 7, the magnetic field generator 104 includes an electromagnet 132 provided as a magnetic field coil unit formed of a set of magnetic field coils 134. The magnetic field generator 104 also includes a current source 136 configured to supply electric current the magnetic field coils 134, so that the magnetic field coils 134 can generate the Z-pinch-stabilizing magnetic field 130 within the plasma chamber 20. It is appreciated that various other types of electromagnets, whether coil-based or non-coil-based, can be used in other embodiments to generate the Z-pinch-stabilizing magnetic field 130.

In the illustrated embodiment, the electromagnet 132 includes six magnetic field coils 134 coaxially wound about, and longitudinally distributed along, the Z-pinch axis 114. However, in other embodiments, less symmetrical or otherwise different arrangements may be used, which may include fewer or more magnetic field coils 134. For example, in some embodiments, the number of coils 134 may range from one to about ten. Depending on the application, each coil 134 may be either a single-turn or a multi-turn coil, and may include any suitable number of axial turns and radial turns.

In some embodiments, the longitudinal component of the Z-pinch-stabilizing magnetic field 130 may have a strength ranging from about 0.1 T to about 10 T in the vicinity of the Z-pinch axis 114. Depending on the polarity of electric current circulating into magnetic field coils 134, the longitudinal component of the Z-pinch-stabilizing magnetic field 130 can point either forward (i.e., from the front end 142 of the inner electrode 116 to the front end 146 of the outer electrode 118) or rearward (i.e., from the front end 146 of the outer electrode 118 to the front end 142 of the inner electrode 116). In some embodiments, the Z-pinch-stabilizing magnetic field 130 may be substantially uniform in the vicinity of the Z-pinch axis 114, although this is not a requirement. Depending on the application, the Z-pinch-stabilizing magnetic field 130 may be a static or quasistatic magnetic field.

It is appreciated that when the Z-pinch-stabilizing magnetic field 130 generated by the magnetic field generator 104 is referred to herein as being “longitudinal” or “axial”, this should not be construed as meaning that the Z-pinch-stabilizing magnetic field 130 is strictly longitudinal or axial within the plasma chamber 120. Rather, this should be construed as meaning that that the Z-pinch-stabilizing magnetic field 130 generated by the magnetic field generator 104 is at least partly, and typically predominantly, longitudinal or axial within the plasma chamber 120, especially in the vicinity of the Z-pinch axis 114, where the Z-pinch plasma 124 is formed.

The application of an axial magnetic field 130 to the Z-pinch plasma 124 after the Z-pinch plasma 124 has been formed can improve the stability of the Z-pinch plasma 124 against MHD instabilities, and thus increase the pinch lifetime. One reason is that when the unstable m=0 and m=1 MHD modes try to bend or compress the magnetic field lines, the axial magnetic field 130 can act to exert a restoring force on the Z-pinch plasma 124 to reduce instabilities in the radial direction. The application of the Z-pinch-stabilizing magnetic field 130 can also increase the Z-pinch density and temperature by providing an additional compressive force. In the illustrated embodiment, the Z-pinch plasma 124 is stabilized by two substantially orthogonal magnetic fields: (i) the azimuthal magnetic field 160 generated by the Z-pinch plasma 124 itself, and (ii) the axial magnetic field 130 applied by the magnetic field generator 104. In some embodiments, the plasma generation system 100 can be modeled or thought of as a linear tokamak, where the axial magnetic field 130 applied by the magnetic field generator 104 represents the tokamak toroidal magnetic field and the azimuthal magnetic field 160 generated by the Z-pinch plasma 124 represents the tokamak poloidal magnetic field. In such embodiments, in contrast to a tokamak, the plasma generation system 100 uses only one set of magnetic field coils 134, since the azimuthal magnetic field 160 is self-generated by the Z-pinch plasma 124.

In the illustrated embodiment, the process of generating Z-pinch-stabilizing magnetic field 130 within the plasma chamber 120 is initiated after the Z-pinch plasma 124 has been formed, which is different from a process of forming the Z-pinch plasma 124 in the presence of a pre-existing axial magnetic field within the plasma chamber 120. This is because forming the Z-pinch plasma 124 when an axial magnetic field is already present in the plasma chamber 120 can significantly limit the maximum achievable Z-pinch temperature and density. In contrast, by initiating the process of applying the Z-pinch-stabilizing magnetic field 130 only after the formation of the Z-pinch plasma 124 has already occurred, the present techniques can allow for higher Z-pinch temperature and density to be achieved.

In some embodiments, the operation of generating the Z-pinch-stabilizing magnetic field 130 can be initiated with a time delay ranging from about slightly more than zero (e.g., one or a few nanoseconds) to about one or a few microseconds (e.g., 10 μs) after the Z-pinch plasma 124 has been formed. In some embodiments, the rise time of the magnetic field coils 134 is sufficiently short (e.g., shorter than the Z-pinch lifetime) to allow for (i) the magnetic field coils 134 to be triggered after the Z-pinch plasma 124 has been formed, and (ii) the Z-pinch-stabilizing magnetic field 130 to be established while the Z-pinch plasma 124 is still stable. In some embodiments, the rise time of the magnetic coils 134 can range from about 100 nanoseconds to about 10 microseconds, although other rise time values can be used in other embodiments. In some embodiments, if the rise time is not short enough, the magnetic field coils 134 may be triggered while the Z-pinch plasma 124 is still forming, in order to compensate for the longer rise time.

Various techniques can be used to synchronize, coordinate, or otherwise control the operation of the magnetic field generator 104 (e.g., the operation of the current source 136) and the operation of the plasma generator 102 (e.g., the operation of the precursor supply unit 110 and/or the power supply unit 112) to ensure or help ensure that the Z-pinch-stabilizing magnetic field 130 is applied only after the Z-pinch plasma 124 has been formed. For example, in one implementation of a sheared-flow-stabilized Z-pinch plasma generation system, the pinch column may start forming about 5 to 50 microseconds (e.g., 20 microseconds) after the capacitor bank discharge, and the pinch lifetime may be about 1 to 20 microseconds (e.g., 5 microseconds) In such an implementation, the current source 36 may begin driving the magnetic field coils 134 about 20 microseconds after the capacitor bank discharge, and the magnetic field coils 134 may have a rise time that is less about 5 microseconds. Diagnostic tools and equipment, such as Rogowski coils, photodetectors, or high-frequency high-voltage probes, can be used to perform timing measurements.

Referring still to FIGS. 6 and 7, the control and processing device 106 may be configured to control the respective operations of the plasma generator 102 and the magnetic field generator 104 to provide suitable a time delay between the formation of the Z-pinch plasma 124 and the onset of the Z-pinch-stabilizing magnetic field 130. The control and processing device 106 may be implemented in hardware, software, firmware, or any combination thereof, and be connected to various components of the plasma generation system 100 via wired and/or wireless communication links to send and/or receive various types of signals (e.g., timing and control signals, measurement signals, and data signals). The control and processing device 106 may be controlled by direct user input and/or by programmed instructions, and may include an operating system for controlling and managing various functions of the plasma generation system 100. Depending on the application, the control and processing device 106 may be fully or partly integrated with, or physically separate from, the other hardware components of the plasma generation system 100.

The processor 138 can implement operating systems, and may be able to execute computer programs, also known as commands, instructions, functions, processes, software codes, executables, applications, and the like. While the processor 138 is depicted in FIG. 7 as a single entity for illustrative purposes, the term “processor” should not be construed as being limited to a single processing entity, and accordingly, any known processor architecture may be used. In some embodiments, the processor 138 may include a plurality of processing entities. Such processing entities may be physically located within the same device, or the processor 138 may represent the processing functionalities of a plurality of devices operating in coordination. For example, the processor 138 may include or be part of one or more of a computer; a microprocessor; a microcontroller, a coprocessor; a central processing unit (CPU); a special-purpose programmable logic device embodied in hardware device, such as, for example, a field-programmable gate array (FPGA) or an application-specific integrated circuit (ASIC); a digital processor; an analog processor; and/or other mechanisms configured to electronically process information and to operate collectively as a processor.

The memory 140, which may also be referred to as a “computer readable storage medium” or a “computer readable memory” is configured to store computer programs and other data to be retrieved by the processor 138. The terms “computer readable storage medium” and “computer readable memory” refer herein to a non-transitory and tangible computer product that can store and communicate executable instructions for the implementation of various steps of the techniques disclosed herein. The memory 140 may be any computer data storage device or assembly of such devices, including a random-access memory (RAM); a dynamic RAM; a read-only memory (ROM); a magnetic storage device; an optical storage device; a flash drive memory; and/or any other non-transitory memory technologies. The memory 140 may be associated with, coupled to, or included in the processor 138, and the processor 138 may be configured to execute instructions contained in a computer program stored in the memory 140 and relating to various functions and operations associated with the processor 138. While the memory 140 is depicted in FIG. 7 as a single entity for illustrative purposes, the term “memory” should not be construed as being limited to a single memory unit, and accordingly, any known memory architecture may be used. In some embodiments, the memory 140 may include a plurality of memory units. Such memory units may be physically located within the same device, or the memory 140 can represent the functionalities of a plurality of devices operating in coordination.

The plasma generation system 100 may also include one or more user interface devices (not shown) operatively connected to the control and processing device 106 to allow the input of commands and queries to the plasma generation system 100, as well as present the outcomes of the commands and queries. The user interface devices can include input devices (e.g., a touch screen, a keypad, a keyboard, a mouse, a switch, and the like) and output devices (e.g., a display screen, a printer, visual and audible indicators and alerts, and the like).

Referring still to FIGS. 7 and 8, in some embodiments, the plasma generation system 100 may include a vacuum system 162. The vacuum system 162 may include a vacuum chamber 164, for example, a pressure vessel or tank (e.g., made of stainless steel). The vacuum chamber 164 may be configured to contain, at least partially, various components of the plasma generation system 100, including at least part of the inner electrode 116 and the outer electrode 118. The vacuum chamber 164 may include various ports, for example, to allow the precursor supply unit 110 to be coupled to the interior of the plasma chamber 120. The vacuum system 162 may also include a pressure control system (not shown) configured to control the operating pressure inside the vacuum chamber 164. In some embodiments, the pressure inside the vacuum chamber may range from about 10⁻⁹ Torr to about 20 Torr, although other ranges of pressure may be used in other embodiments.

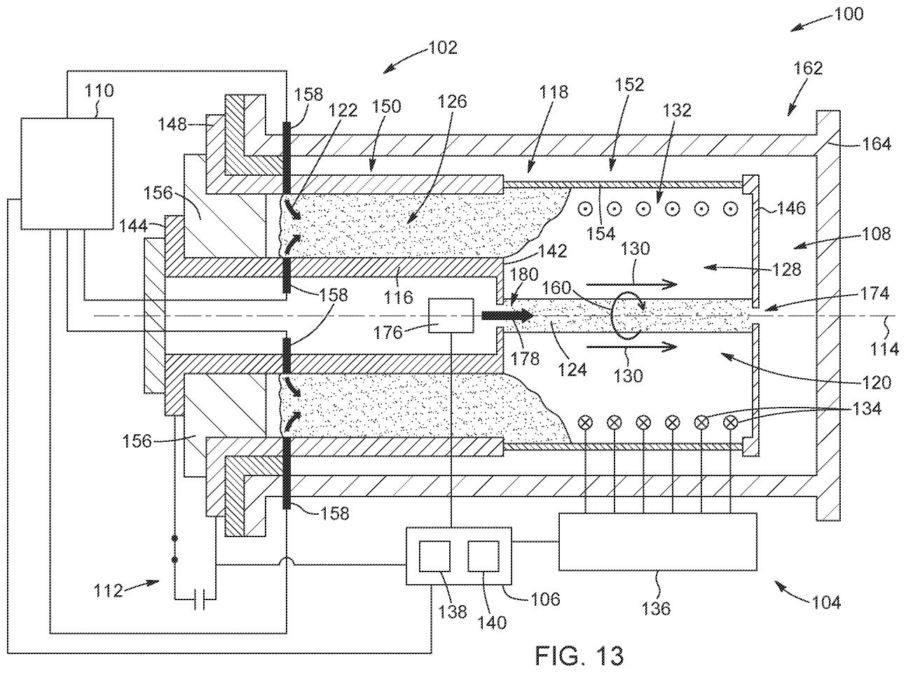

Referring to FIG. 13, there is illustrated a schematic longitudinal cross-sectional view of a plasma generation system 100, in accordance with another embodiment. The embodiment of FIG. 13 shares several features with the embodiment of FIGS. 7 and 8, which need not be described again other than to highlight differences between them. In FIG. 13, the plasma generation system 100 includes a neutral beam injection (NBI) unit 176 configured to generate a beam 178 of neutral particles and inject the beam 178 of neutral particles into the plasma chamber 120 to heat, enhance, supplement, and/or stabilize the Z-pinch plasma 124. In particular, the neutral particles can be coupled inside the Z-pinch plasma 124 for heating and current drive.

NBI is method in which a beam of high-energy neutral particles is supplied and coupled to a plasma to provide heating and fueling. Being chargeless, the neutral atoms can enter the magnetic confinement field and be ionized via collisions with the ions and electrons in the plasma. The ionized particles thus generated are retained in the magnetic confinement field and are able to transfer their energy to the plasma ion and electrons. In the illustrated embodiment, using NBI can provide heating, momentum, fueling, and current drive to the Z-pinch plasma 124, which can allow higher fusion power gain to be achieved and sustained over longer periods of time, with reduced or better controlled power losses and other energy inefficiencies. In some embodiments, combining magnetic field stabilization to stabilize the Z-pinch plasma 124 and neutral beam injection to heat up the Z-pinch plasma 124 and achieve higher pinch temperatures can be advantageous to help achieving fusion conditions. In some embodiments, both neutral beam injection and magnetic field stabilization can be initiated only a few nanoseconds after pinch formation.

In some embodiments, the NBI unit 176 can include an ion source (e.g., a plasma source) configured to produce an ion beam, which can be positive-ion beam or a negative-ion beam, an accelerator (e.g., an electrostatic accelerator) configured to accelerate the ion beam, a neutralizer (e.g. a gas-cell neutralizer) configured to partly or fully neutralize the accelerated ion beam, and a residual ion dump configured to separate (e.g., using magnets) remaining ions from neutrals to produce the neutral beam 178. The neutral beam 178 can be injected in the plasma confinement device 108 to couple into the Z-pinch plasma 124 using any suitable methods. Being chargeless, the particles forming the neutral beam 178 can enter the magnetic confinement field of the Z-pinch plasma 124, where they can heat and fuel the Z-pinch plasma 124 via collisions with the plasma species. It is appreciated that the theory, configuration, implementation, and operation of NBI techniques as a plasma heating method are generally known in the art and need not be described in detail herein other than to facilitate an understanding of the present techniques.

The neutral particles forming the neutral beam 178 may include any suitable particles suitable for use in NBI. In some embodiments, the neutral beam 178 may include isotopes of hydrogen (e.g., protium, deuterium, or a mixture of deuterium and tritium). Other possible examples include helium-3 and boron-11. The beam power and the average neutral particle energy can be adjusted based on the density and the temperature of the Z-pinch plasma 124.

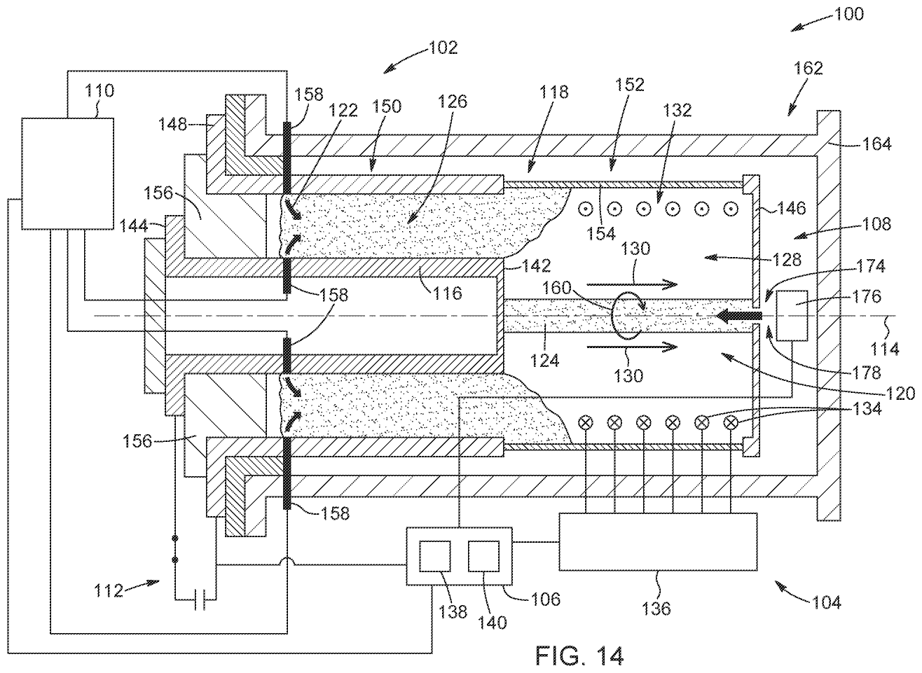

The neutral beam 178 may be injected into the Z-pinch plasma 124 from any suitable location of the plasma confinement device 108 and through any suitable mode of injection. For example, in the embodiment of FIG. 13, the NBI unit 176 is provided inside the inner electrode 116, and the neutral beam 178 is injected into the Z-pinch plasma 124 via an NBI port 180 formed through the front end 142 of the inner electrode 116. Other arrangements are possible. For example, in the embodiment of FIG. 14, the NBI unit 176 is provided outside the plasma confinement device 108, and the neutral beam 178 is injected into the Z-pinch plasma 124 via an NBI port formed through a front endwall at the front end 146 of the outer electrode 118 (the NBI port embodied by the plasma exit port 174 in this embodiment). In yet other embodiments, a neutral beam 178 may be injected into the Z-pinch plasma 124 from both within the inner electrode 116 and outside the outer electrode 118.

Depending on the application, a given NBI port 180 may be located either on the Z-pinch axis 114, so that the injection angle between the NBI direction and the Z-pinch axis 114 is substantially equal to zero, or radially offset from the Z-pinch axis 114, so that the injection angle between the NBI direction and the Z-pinch axis is different from zero. In some embodiments, the neutral beam 178 may be shaped (e.g., in terms of its cross-sectional shape and/or size), directed (e.g., focused toward a certain focal point within the plasma chamber 120 or injected at a certain divergence angle), or otherwise conditioned as it propagates toward the Z-pinch plasma 124. Beam conditioning can be performed in order to increase the efficiency with which the neutral beam 178 couples into the Z-pinch plasma 114, and in turn to provide better control over the heating provided by the neutral beam 178 and its impact on the Z-pinch lifetime and properties. In general, it is appreciated that various NBI configurations are contemplated for use in the present techniques, In particular, the structure, configuration, and operation of the NBI unit 176, along with the NBI port number and location may be varied in accordance with the application.

It is appreciated that the embodiments of FIGS. 13 and 14 are provided by way of example only, and that the present techniques contemplate using NBI for plasma heating in various other types of Z-pinch plasma generation systems, in both fusion and non-fusion applications. In some embodiments, NBI can be replaced with, or supplemented by, ion beam injection to heat and stabilize the Z-pinch plasma 124.

It is also appreciated that the plasma generation systems 100 illustrated in the embodiments of FIGS. 7 to 14 are provided by way of example only, and that the present techniques contemplate using a Z-pinch-stabilizing magnetic field in various other types of Z-pinch-based plasma generation systems, both in fusion and non-fusion applications.

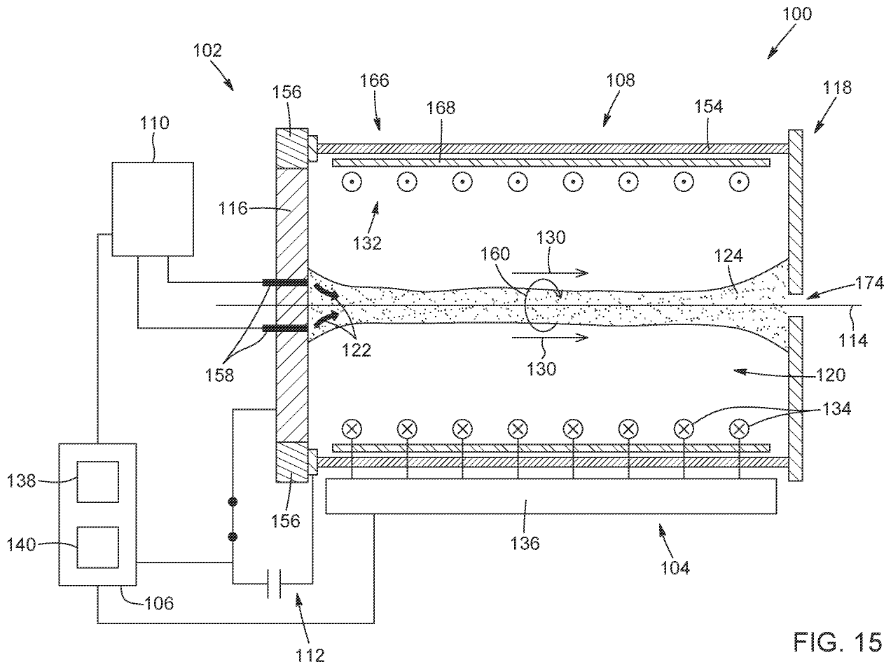

Referring to FIGS. 15 to 18, in some embodiments, the magnetic-field-stabilized Z-pinch-based plasma generation system 100 may not include a coaxial acceleration region followed by a pinch assembly region, as in the embodiments of FIGS. 7 to 14.

FIG. 15 illustrates a schematic longitudinal cross-sectional view of a plasma generation system 100, in accordance with another embodiment. The embodiment of FIG. 15 shares several features with the embodiments of FIGS. 7 to 14, which need not be described again other than to highlight differences between them. The plasma generation system 100 of FIG. 15 generally includes a plasma generator 102, a magnetic field generator 104, and a control and processing device 106.

The plasma generator 102 includes a plasma confinement device 108, a precursor supply unit 110, and a power supply unit 112. The plasma confinement device 108 includes a first electrode 116 and a second electrode 118 arranged with respect to each other to define a plasma chamber 120 therebetween. The plasma chamber 120 extends along a Z-pinch axis 114. The precursor supply unit 110 is coupled to the plasma confinement device 108 and configured to supply a plasma precursor 122 within the plasma chamber 120. Depending on the application, the plasma precursor 122 may be a neutral or partially (e.g., weakly) ionized gas or gas mixture, a plasma, or a combination thereof. The power supply unit 112 is configured to apply a voltage between the first electrode 116 and the second electrode 118 to energize the plasma precursor 122 into a Z-pinch plasma 124. In some embodiments, the precursor supply unit 110 may be configured to provide the plasma precursor 122 as an initial plasma and to supply the plasma precursor 122 in the plasma chamber 120 with a plasma velocity that is radially sheared along the Z-pinch axis 114, so as to provide the Z-pinch plasma 124 with an embedded sheared axial flow. Non-limiting examples of techniques for injecting an initial plasma with a radially sheared velocity profile into a plasma chamber and compressing the injected initial plasma into a Z-pinch plasma with an embedded sheared axial flow are disclosed in International Patent Application PCT/US2022/012502, filed Jan. 14, 2022 and published as WO 2022/155462 on Jul. 21, 2022, the contents of which are incorporated herein by reference in their entirety. However, in other applications, the plasma generation system 100 depicted in FIG. 15 may be configured to generate the Z-pinch plasma 124 without a radial velocity shear (e.g., as a linear Z-pinch with a purely axial flow).

In FIG. 15, the second electrode 118 has a peripheral electrode section 166 disposed around the Z-pinch axis 114 and circumferentially enclosing the plasma chamber 120. The peripheral electrode section 166 of the second electrode 118 includes a plurality of electrically conducting rods 154 extending parallel to, and distributed azimuthally about, the Z-pinch axis 114. Thus, the peripheral electrode section 166 has a discontinuous peripheral surface, with inter-rod gaps provided by the azimuthal spaces between the rods 154. The rods 154 may be made of any suitable electrically conductive material, such as various metals and metal alloys. In some embodiments, a thin cylindrical shell 168 made of an electrically insulating material may be provided inside the plasma chamber 120, close to but radially inwardly of the rods 154, to ease the Z-pinch formation process. Providing the shell 168 can prevent or help prevent electrical arcing from the Z-pinch plasma 124 to the second electrode 118, which could otherwise damage the second electrode 118.

The magnetic field generator 104 is arranged with respect to the plasma generator 102 and configured to generate, after the Z-pinch plasma 124 has been formed, a Z-pinch-stabilizing magnetic field 130 extending longitudinally within the plasma chamber 120 for stabilizing the Z-pinch plasma 124. The magnetic field generator 104 includes an electromagnet 132 and a current source 136 coupled to the electromagnet 132. The electromagnet 132 includes a magnetic field coil unit having one or more magnetic coils 134 coaxially wound about, and longitudinally distributed along, the Z-pinch axis 114. The current source 136 is configured to supply electric current to the electromagnet 132, so that the electromagnet 132 generates the Z-pinch-stabilizing magnetic field 130. In the embodiment of FIG. 15, the magnetic field coils 134 are surrounded by the rods 154, so that they are inside the plasma chamber 120. Depending on the application, the magnetic field coils 134 may be provided either radially inside, as in FIG. 15, or radially outside the insulating cylindrical shell 168.

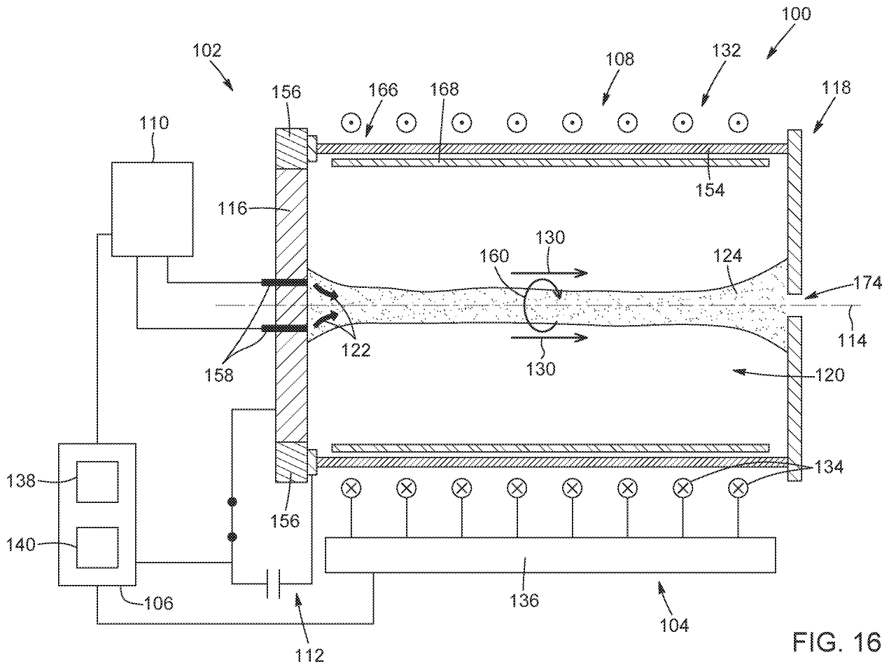

Referring to FIG. 16, there is illustrated a schematic longitudinal cross-sectional view of a plasma generation system 100, in accordance with another embodiment. The embodiment of FIG. 16 shares several features with the embodiment of FIG. 15, which need not be described again other than to highlight differences between them. In FIG. 16, the magnetic field coils 134 are disposed around rods 154 and outside the plasma chamber 120, rather than being enclosed by the rods 154 and inside the plasma chamber 120 as in FIG. 15.

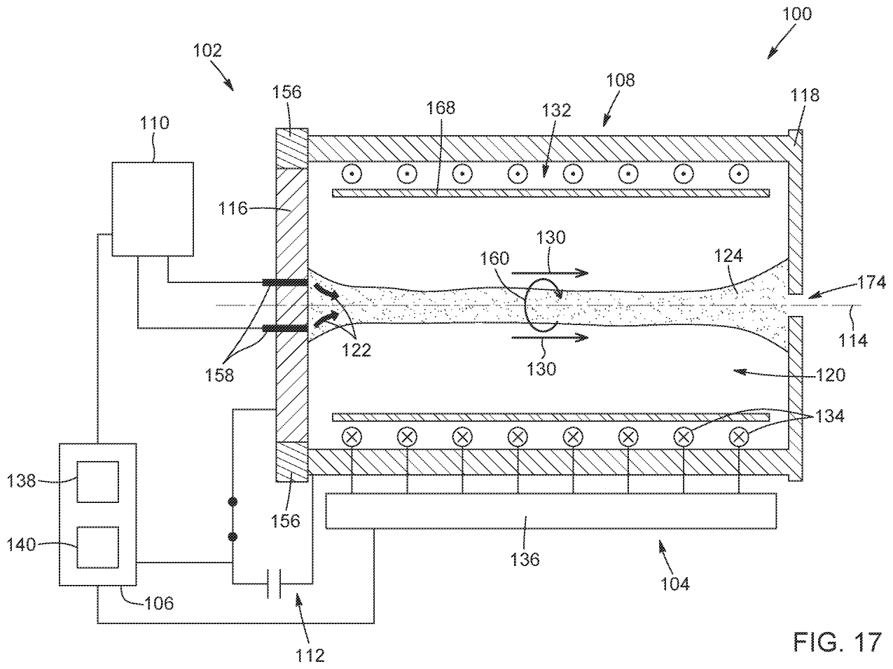

Referring to FIG. 17, there is illustrated a schematic longitudinal cross-sectional view of a plasma generation system 100, in accordance with another embodiment. The embodiment of FIG. 17 shares several features with the embodiment of FIG. 15, which need not be described again other than to highlight differences between them. In FIG. 17, the peripheral electrode section 166 of the outer electrode 118 has a continuous, uninterrupted cylindrical peripheral wall, rather than including a distribution of rods separated from one another by inter-rod gaps as FIG. 15. In FIG. 17, the magnetic field coils 134 are disposed within the plasma chamber 120, near the inner peripheral surface of the peripheral electrode section 166.

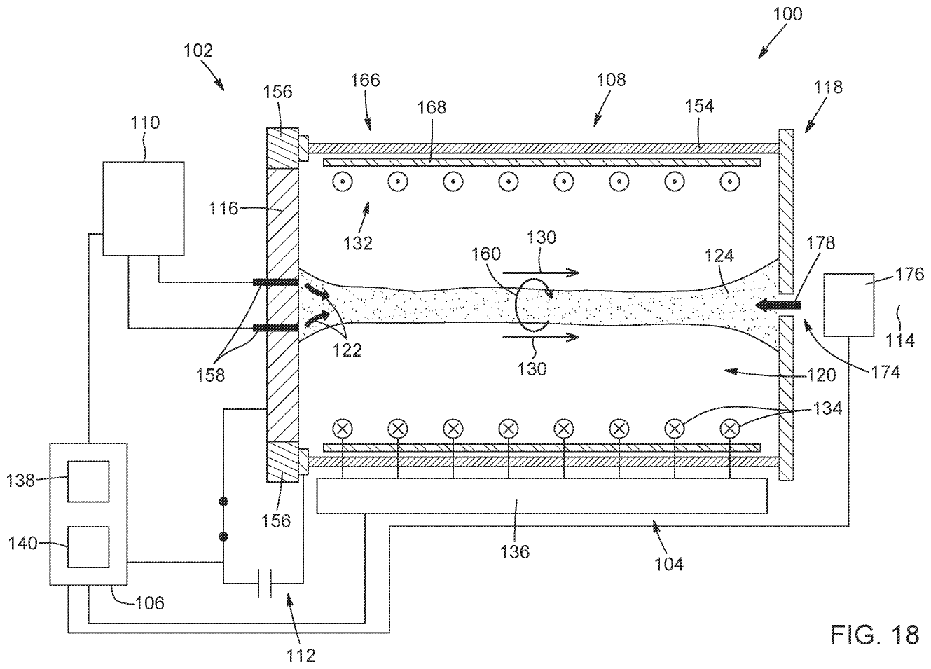

Referring to FIG. 18, there is illustrated a schematic longitudinal cross-sectional view of a plasma generation system 100, in accordance with another embodiment. The embodiment of FIG. 18 shares several features with the embodiment of FIG. 15, which need not be described again other than to highlight differences between them. In FIG. 18, the plasma generation system 100 includes an NBI unit 176 configured to inject a beam 178 of neutral particles in the plasma chamber 120 to be coupled into and beat the Z-pinch plasma 124. In the illustrated embodiment, the NBI unit 176 is disposed on the Z-pinch axis 114, outside the plasma chamber 120, and is configured to inject the neutral beam 178 via a plasma exit port 174 formed through the front end 146 of the outer electrode 118. As noted above with respect to FIGS. 13 and 14, the NBI port number and location can be varied depending on the application.

The following aspects are also disclosed herein:

1. A plasma generation system, comprising:
a plasma generator comprising a plasma chamber having a longitudinal Z-pinch axis, the plasma generator being configured to generate a Z-pinch plasma along the Z-pinch axis within the plasma chamber; and
a magnetic field generator arranged with respect to the plasma generator and configured to generate, after the Z-pinch plasma has been formed, a Z-pinch-stabilizing magnetic field extending longitudinally within the plasma chamber for stabilizing and compressing the Z-pinch plasma.
   2. The plasma generation system of aspect 1, further comprising a control and processing unit comprising a processor and a non-transitory computer readable storage medium having stored thereon computer readable instructions that, when executed by the processor, cause the control and processing unit to control the plasma generator and the magnetic field generator to provide a time delay between the formation of the Z-pinch plasma and the generation of the Z-pinch-stabilizing magnetic field.
   3. The plasma generation system of aspect 2, wherein the time delay ranges from about 1 nanosecond to about 10 microseconds.
   4. The plasma generation system of any one of aspects 1 to 3, wherein the magnetic field generator comprises an electromagnet and a current source coupled to the electromagnet to supply electric current to the electromagnet for the electromagnet to generate the Z-pinch-stabilizing magnetic field.
   5. The plasma generation system of aspect 4, wherein the electromagnet comprises a set of magnetic field coils coaxially wound about, and longitudinally distributed along, the Z-pinch axis.
   6. The plasma generation system of aspect 5, wherein the set of magnetic field coils is disposed inside the plasma chamber.
   7. The plasma generation system of aspect 5, wherein the set of magnetic field coils is disposed outside the plasma chamber.
   8. The plasma generation system of any one of aspects 1 to 7, wherein the plasma generator comprises:
a plasma confinement device comprising:
   a first electrode; and
   a second electrode arranged with respect to the first electrode to define therebetween the plasma chamber;
a precursor supply unit coupled to the plasma confinement device and configured to supply a plasma precursor within the plasma chamber; and
a power supply unit configured to apply a discharge driving signal to the first electrode and the second electrode to energize the plasma precursor into the Z-pinch plasma.
   9. The plasma generation system of aspect 8, wherein the plasma precursor is a precursor gas.
   10. The plasma generation system of aspect 8, wherein the plasma precursor is a precursor plasma.
   11. The plasma generation system of any one of aspects 8 to 10, wherein the plasma precursor comprises deuterium, tritium, hydrogen, helium, or any combination thereof.
   12. The plasma generation system of any one of aspects 8 to 11, wherein:
the first electrode and the second electrode are provided in a coaxial arrangement with respect to the Z-pinch axis; and
the second electrode comprises:
   a rear electrode section disposed around the first electrode to define an acceleration region therebetween; and
   a front electrode section extending forwardly beyond the first electrode along the Z-pinch axis to define an assembly region, the acceleration region and the assembly region forming the plasma chamber; and
the magnetic field generator is configured to generate the Z-pinch-stabilizing magnetic field within the assembly region.
   13. The plasma generation system of aspect 12, wherein the front electrode section comprises a plurality of rods extending parallel to, and distributed azimuthally about, the Z-pinch axis.
   14. The plasma generation system of aspect 13, wherein the rods have an adjustable length along the Z-pinch axis to control a length of the plasma chamber.
   15. The plasma generation system of aspect 13 or 14, wherein the magnetic field generator comprises a set of magnetic field coils to generate the Z-pinch-stabilizing magnetic field, the set of magnetic field coils being coaxially wound about, and longitudinally distributed along, the Z-pinch axis.
   16. The plasma generation system of aspect 15, wherein the set of magnetic field coils is disposed around the plurality of rods.
   17. The plasma generation system of aspect 16, wherein:
the front electrode section has a longitudinally tapered configuration, wherein each rod comprises a rear rod segment extending longitudinally and radially inwardly from the rear electrode section, and a front rod segment extending longitudinally from the rear rod segment; and
the set of magnetic field coils disposed at least around the rear rod segments of the plurality of rods.
   18. The plasma generation system of aspect 15, wherein the plurality of rods is disposed around the set of magnetic field coils.
   19. The plasma generation system of any one of aspects 1 to 18, further comprising a neutral beam injection unit configured to generate a beam of neutral particles and inject the beam of neutral particles into the plasma chamber to heat and stabilize the Z-pinch plasma.
   20. The plasma generation system of any one of aspects 1 to 19, wherein the plasma generator is configured to form the Z-pinch plasma with an embedded radially sheared axial flow.
   21. A plasma generation method comprising:
forming a Z-pinch plasma extending along a longitudinal Z-pinch axis of a plasma chamber; and
generating, after the Z-pinch plasma has been formed, a Z-pinch-stabilizing magnetic field extending longitudinally within the plasma chamber for stabilizing and compressing the Z-pinch plasma.
   22. The plasma generation method of aspect 21, wherein the Z-pinch-stabilizing magnetic field is generated with a time delay ranging from about 1 nanosecond to about 10 microseconds after the Z-pinch plasma has been formed.
   23. The plasma generation method of aspect 21 or 22, wherein generating the Z-pinch-stabilizing magnetic field comprises:
providing an electromagnet and a current source coupled to the electromagnet; and
operating the current source to supply electric current to the electromagnet for the electromagnet to generate the Z-pinch-stabilizing magnetic field.
   24. The plasma generation method of aspect 23, wherein the electromagnet comprises a set of magnetic field coils coaxially wound about, and longitudinally distributed along, the Z-pinch axis.
   25. The plasma generation method of aspect 24, wherein the set of magnetic field coils is disposed inside the plasma chamber.
   26. The plasma generation method of aspect 24, wherein the set of magnetic field coils is disposed outside the plasma chamber.
   27. The plasma generation method of any one of aspects 21 to 26, wherein forming a Z-pinch plasma comprises:
providing a plasma confinement device comprising a first electrode and a second electrode arranged with respect to the first electrode to define therebetween the plasma chamber;
supplying a plasma precursor within the plasma chamber; and
applying a discharge driving signal to the first electrode and the second electrode to energize the plasma precursor into the Z-pinch plasma.
   28. The plasma generation method of aspect 27, wherein the plasma precursor is a precursor gas.
   29. The plasma generation method of aspect 27, wherein the plasma precursor is a precursor plasma.
   30. The plasma generation method of any one of aspects 27 to 29, wherein:
providing the plasma confinement device comprises:
   disposing the first electrode and the second electrode are provided in a coaxial arrangement with respect to the Z-pinch axis; and
   providing the second electrode with a rear electrode section disposed around the first electrode to define an acceleration region therebetween, and a front electrode section extending forwardly beyond the first electrode along the Z-pinch axis to define an assembly region, the acceleration region and the assembly region forming the plasma chamber; and
the Z-pinch-stabilizing magnetic field is generated within the assembly region.
   31. The plasma generation method of aspect 30, wherein the front electrode section comprises a plurality of rods extending parallel to, and distributed azimuthally about, the Z-pinch axis.
   32. The plasma generation method of aspect 31, further comprising:
providing a set of magnetic field coils being coaxially wound about, and longitudinally distributed along, the Z-pinch axis; and
using the set of magnetic field coils to generate the Z-pinch-stabilizing magnetic field.
   33. The plasma generation method of aspect 32, further comprising disposing the set of magnetic field coils disposed around the plurality of rods.
   34. The plasma generation method of aspect 32, further comprising disposing the plurality of rods around the set of magnetic field coils.
   35. The plasma generation method of any one of aspects 21 to 34, further comprising injecting a beam of neutral particles into the plasma chamber to heat and stabilize the Z-pinch plasma.
   36. The plasma generation system of any one of aspects 21 to 35, wherein forming the Z-pinch plasma comprising forming the Z-pinch plasma with an embedded radially sheared axial flow.

Numerous modifications could be made to the embodiments described above without departing from the scope of the appended claims.

1. A plasma generation system, comprising:
a plasma generator comprising a plasma chamber having a longitudinal Z-pinch axis, the plasma generator being configured to generate a Z-pinch plasma along the Z-pinch axis within the plasma chamber; and
a magnetic field generator arranged with respect to the plasma generator and configured to generate, after the Z-pinch plasma has been formed, a Z-pinch-stabilizing magnetic field extending longitudinally within the plasma chamber for stabilizing and compressing the Z-pinch plasma.

2. The plasma generation system of claim 1, further comprising a control and processing unit comprising a processor and a non-transitory computer readable storage medium having stored thereon computer readable instructions that, when executed by the processor, cause the control and processing unit to control the plasma generator and the magnetic field generator to provide a time delay between the formation of the Z-pinch plasma and the generation of the Z-pinch-stabilizing magnetic field.

3. The plasma generation system of claim 2, wherein the time delay ranges from about 1 nanosecond to about 10 microseconds.

4. The plasma generation system of claim 1, wherein the magnetic field generator comprises an electromagnet and a current source coupled to the electromagnet to supply electric current to the electromagnet for the electromagnet to generate the Z-pinch-stabilizing magnetic field.

5. The plasma generation system of claim 4, wherein the electromagnet comprises a set of magnetic field coils coaxially wound about, and longitudinally distributed along, the Z-pinch axis.

6. The plasma generation system of claim 5, wherein the set of magnetic field coils is disposed inside the plasma chamber.

7. The plasma generation system of claim 5, wherein the set of magnetic field coils is disposed outside the plasma chamber.

8. The plasma generation system of claim 1, wherein the plasma generator comprises:
a plasma confinement device comprising:
a first electrode; and
a second electrode arranged with respect to the first electrode to define therebetween the plasma chamber;
a precursor supply unit coupled to the plasma confinement device and configured to supply a plasma precursor within the plasma chamber; and
a power supply unit configured to apply a discharge driving signal to the first electrode and the second electrode to energize the plasma precursor into the Z-pinch plasma.

9. The plasma generation system of claim 8, wherein the plasma precursor is a precursor gas.

10. The plasma generation system of claim 8, wherein the plasma precursor is a precursor plasma.

11. The plasma generation system of claim 8, wherein the plasma precursor comprises deuterium, tritium, hydrogen, helium, or any combination thereof.

12. The plasma generation system of claim 8, wherein:
the first electrode and the second electrode are provided in a coaxial arrangement with respect to the Z-pinch axis; and
the second electrode comprises:
a rear electrode section disposed around the first electrode to define an acceleration region therebetween; and
a front electrode section extending forwardly beyond the first electrode along the Z-pinch axis to define an assembly region, the acceleration region and the assembly region forming the plasma chamber; and
the magnetic field generator is configured to generate the Z-pinch-stabilizing magnetic field within the assembly region.

13. The plasma generation system of claim 12, wherein the front electrode section comprises a plurality of rods extending parallel to, and distributed azimuthally about, the Z-pinch axis.

14. The plasma generation system of claim 13, wherein the rods have an adjustable length along the Z-pinch axis to control a length of the plasma chamber.

15. The plasma generation system of claim 13, wherein the magnetic field generator comprises a set of magnetic field coils to generate the Z-pinch-stabilizing magnetic field, the set of magnetic field coils being coaxially wound about, and longitudinally distributed along, the Z-pinch axis.

16. The plasma generation system of claim 15, wherein the set of magnetic field coils is disposed around the plurality of rods.

17. The plasma generation system of claim 16, wherein:
the front electrode section has a longitudinally tapered configuration, wherein each rod comprises a rear rod segment extending longitudinally and radially inwardly from the rear electrode section, and a front rod segment extending longitudinally from the rear rod segment; and
the set of magnetic field coils disposed at least around the rear rod segments of the plurality of rods.

18. The plasma generation system of claim 15, wherein the plurality of rods is disposed around the set of magnetic field coils.

19. The plasma generation system of claim 1, further comprising a neutral beam injection unit configured to generate a beam of neutral particles and inject the beam of neutral particles into the plasma chamber to heat and stabilize the Z-pinch plasma.

20. The plasma generation system of claim 1, wherein the plasma generator is configured to form the Z-pinch plasma with an embedded radially sheared axial flow.

21. A plasma generation method comprising:
forming a Z-pinch plasma extending along a longitudinal Z-pinch axis of a plasma chamber; and
generating, after the Z-pinch plasma has been formed, a Z-pinch-stabilizing magnetic field extending longitudinally within the plasma chamber for stabilizing and compressing the Z-pinch plasma.

22. The plasma generation method of claim 21, wherein the Z-pinch-stabilizing magnetic field is generated with a time delay ranging from about 1 nanosecond to about 10 microseconds after the Z-pinch plasma has been formed.

23. The plasma generation method of claim 21, wherein generating the Z-pinch-stabilizing magnetic field comprises:
providing an electromagnet and a current source coupled to the electromagnet; and
operating the current source to supply electric current to the electromagnet for the electromagnet to generate the Z-pinch-stabilizing magnetic field.

24. The plasma generation method of claim 23, wherein the electromagnet comprises a set of magnetic field coils coaxially wound about, and longitudinally distributed along, the Z-pinch axis.

25. The plasma generation method of claim 24, wherein the set of magnetic field coils is disposed inside the plasma chamber.

26. The plasma generation method of claim 24, wherein the set of magnetic field coils is disposed outside the plasma chamber.

27. The plasma generation method of claim 21, wherein forming a Z-pinch plasma comprises:
providing a plasma confinement device comprising a first electrode and a second electrode arranged with respect to the first electrode to define therebetween the plasma chamber;
supplying a plasma precursor within the plasma chamber; and
applying a discharge driving signal to the first electrode and the second electrode to energize the plasma precursor into the Z-pinch plasma.

28. The plasma generation method of claim 27, wherein the plasma precursor is a precursor gas.

29. The plasma generation method of claim 27, wherein the plasma precursor is a precursor plasma.

30. The plasma generation method of claim 21, wherein:
providing the plasma confinement device comprises:
disposing the first electrode and the second electrode are provided in a coaxial arrangement with respect to the Z-pinch axis; and
providing the second electrode with a rear electrode section disposed around the first electrode to define an acceleration region therebetween, and a front electrode section extending forwardly beyond the first electrode along the Z-pinch axis to define an assembly region, the acceleration region and the assembly region forming the plasma chamber; and
the Z-pinch-stabilizing magnetic field is generated within the assembly region.

31. The plasma generation method of claim 30, wherein the front electrode section comprises a plurality of rods extending parallel to, and distributed azimuthally about, the Z-pinch axis.

32. The plasma generation method of claim 31, further comprising:
providing a set of magnetic field coils being coaxially wound about, and longitudinally distributed along, the Z-pinch axis; and
using the set of magnetic field coils to generate the Z-pinch-stabilizing magnetic field.

33. The plasma generation method of claim 32, further comprising disposing the set of magnetic field coils disposed around the plurality of rods.

34. The plasma generation method of claim 32, further comprising disposing the plurality of rods around the set of magnetic field coils.

35. The plasma generation method of claim 21, further comprising injecting a beam of neutral particles into the plasma chamber to heat and stabilize the Z-pinch plasma.

36. The plasma generation system of claim 21, wherein forming the Z-pinch plasma comprising forming the Z-pinch plasma with an embedded radially sheared axial flow.
